(19) United States
(12) Patent Application Publication
(10) Pub. No.: US 2026/0133409 A1
(43) Pub. Date: May 14, 2026

(54) OPTICAL IMAGING LENS ASSEMBLY

(71) Applicant: ZHEJIANG SUNNY OPTICS CO., LTD., Yuyao City (CN)

(72) Inventors: Pin ZHAO, Yuyao City (CN); Fang MEI, Yuyao City (CN); Peng GAO, Yuyao City (CN); Fang ZHANG, Yuyao City (CN); Liefeng ZHAO, Yuyao City (CN)

(73) Assignee: ZHEJIANG SUNNY OPTICS CO., LTD., Yuyao City (CN)

(21) Appl. No.: 19/073,931

(22) Filed: Mar. 7, 2025

(30) Foreign Application Priority Data
Nov. 12, 2024 (CN) 202411614377.6

(51) Int. Cl. G02B 13/18; G02B 9/64

(52) U.S. Cl. CPC G02B 13/18; G02B 9/64

(57) ABSTRACT

The present application discloses an optical imaging lens assembly, comprising a lens barrel and a lens group and a supporting member group accommodated in the lens barrel, the lens group comprising a first lens to a seventh lens having refractive powers and arranged in order from an object side to an image side along an optical axis, wherein a difference between maximum outer diameters of the fourth lens and the fifth lens is smaller than a difference between maximum outer diameters of the fifth lens and the sixth lens; the supporting member group comprises a third supporting member, a fourth supporting member, and a fifth supporting member; and the optical imaging lens assembly satisfies:

$$1.8 < FNO / tan ( Semi - FOV ) < 1.95 , \\ 7.75 < EP 45 / ( CP 4 + CP 5 ) < 11.55 and 0.7 < CT 4 / EP 34 * N 4 < 0.96 .$$

### CROSS-REFERENCE TO RELATED APPLICATIONS

The present application claims the priority of Chinese patent application No. 202411614377.6, filed on Nov. 12, 2024, which is hereby incorporated by reference in its entirety.

### TECHNICAL FIELD

The present application relates to the field of optical devices, and specifically, to an optical imaging lens assembly.

### BACKGROUND

In recent years, with the ever-changing consumer demand, the requirements for optical imaging lens assemblies have gradually become more complex and diversified. In different application scenarios, the performance of optical imaging lens assemblies varies.

In the prior art, on the premise of ensuring that an optical imaging lens assembly has a large aperture, after light enters the optical imaging lens assembly, the thickness, shape, etc. of lenses will affect the progression and stability of the light. In a seven-element optical imaging lens assembly, when the radial step difference between the fifth lens and the sixth lens changes greatly, the light emission angle will be uneven, seriously affecting the clarity and resolution of the optical imaging lens assembly, and further affecting the modulation transfer function (MTF) performance of the optical imaging lens assembly.

### SUMMARY

One aspect of the present application provides an optical imaging lens assembly, comprising a lens barrel and a lens group and a supporting member group accommodated in the lens barrel, wherein the number of lenses having refractive powers in the lens group is seven, and the lens group comprises a first lens, a second lens, a third lens, a fourth lens, a fifth lens, a sixth lens and a seventh lens having refractive powers and arranged in order from an object side to an image side along an optical axis, wherein a difference between maximum outer diameters of the fourth lens and the fifth lens is smaller than a difference between maximum outer diameters of the fifth lens and the sixth lens; the supporting member group comprises a third supporting member, a fourth supporting member and a fifth supporting member, the third supporting member is disposed between the third lens and the fourth lens and in contact with an image side surface of the third lens, the fourth supporting member is disposed between the fourth lens and the fifth lens and in contact with an image side surface of the fourth lens, and the fifth supporting member is disposed between the fifth lens and the sixth lens and in contact with an image side surface of the fifth lens; and the optical imaging lens assembly satisfies: 1.80<FNO/tan (Semi-FOV)<1.95; 7.75<EP45/(CP4+CP5)<11.55; and 0.7<CT4/EP34*N4<0.96; where FNO is an f-number of the optical imaging lens assembly, EP45 is a distance from an image side surface of the fourth supporting member to an object side surface of the fifth supporting member along the direction of the optical axis, CP4 is a maximum thickness of the fourth supporting member, CP5 is a maximum thickness of the fifth supporting member, CT4 is a center thickness of the fourth lens on the optical axis, EP34 is a distance from an image side surface of the third supporting member to an object side surface of the fourth supporting member along the direction of the optical axis, N4 is a refractive index of the fourth lens, and Semi-FOV is half of a maximum field-of-view angle of the optical imaging lens assembly.

According to an exemplary implementation of the present application, the supporting member group further comprises a first supporting member, and the first supporting member is disposed between the first lens and the second lens and in contact with an image side surface of the first lens; and the optical imaging lens assembly satisfies: 3.1<d0s/(EP01+CT1)<3.75, where d0s is an inner diameter of an object side end surface of the lens barrel, EP01 is a distance between the object side end surface of the lens barrel and an object side surface of the first supporting member along the direction of the optical axis, and CT1 is a center thickness of the first lens on the optical axis.

According to an exemplary implementation of the present application, the supporting member group further comprises a first supporting member, and the first supporting member is disposed between the first lens and the second lens and in contact with an image side surface of the first lens; and the optical imaging lens assembly satisfies: 0.3<f1/(R1+R2)<0.5 and 1.95<d0s/d1s<2.1, where f1 is an effective focal length of the first lens, R1 is a radius of curvature of an object side surface of the first lens, R2 is a radius of curvature of an image side surface of the first lens, d0s is an inner diameter of an object side end surface of the lens barrel, and d1s is an inner diameter of an object side surface of the first supporting member.

According to an exemplary implementation of the present application, the supporting member group further comprises a first supporting member, and the first supporting member is disposed between the first lens and the second lens and in contact with an image side surface of the first lens; and the optical imaging lens assembly satisfies: 1.65<EP01/SG11<1.9, wherein EP01 is a distance between an object side end surface of the lens barrel and an object side surface of the first supporting member along the direction of the optical axis, and SG11 is an on-axis distance from an intersection of an object side surface of the first lens and the optical axis to a non-effective radial section of the object side surface of the first lens.

According to an exemplary implementation of the present application, the supporting member group further comprises a second supporting member, and the second supporting member is disposed between the second lens and the third lens and in contact with an image side surface of the second lens; and the optical imaging lens assembly satisfies: 0.75<EP23/CT3<1.2, where EP23 is a distance from an image side surface of the second supporting member to an object side surface of the third supporting member along the direction of the optical axis, and CT3 is a center thickness of the third lens on the optical axis.

According to an exemplary implementation of the present application, the optical imaging lens assembly satisfies: 0.45<EP45/CT5<0.7, where CT5 is a center thickness of the fifth lens on the optical axis.

According to an exemplary implementation of the present application, the optical imaging lens assembly satisfies: 3.7<f5/d5s<5.6, where f5 is an effective focal length of the fifth lens, and d5s is an inner diameter of an object side surface of the fifth supporting member.

According to an exemplary implementation of the present application, the optical imaging lens assembly satisfies: 0.55<(R10−R9)/d5s<1.05, where R9 is a radius of curvature of an object side surface of the fifth lens, R10 is a radius of curvature of an image side surface of the fifth lens, and d5s is an inner diameter of an object side surface of the fifth supporting member.

According to an exemplary implementation of the present application, the optical imaging lens assembly satisfies: 0.15<(D5s−D4m)/d4s<0.5, where D5s is an outer diameter of an object side surface of the fifth supporting member, D4m is an outer diameter of an image side surface of the fourth supporting member, and d4s is an inner diameter of an object side surface of the fourth supporting member.

According to an exemplary implementation of the present application, the optical imaging lens assembly satisfies: 10.35<T34/CP3<16.6, where T34 is an air gap between the third lens and the fourth lens on the optical axis, and CP3 is a maximum thickness of the third supporting member.

According to an exemplary implementation of the present application, the optical imaging lens assembly satisfies: 1.65<EP01/SG11<1.9, where EP01 is a distance between an object side end surface of the lens barrel and an object side surface of the first supporting member along the direction of the optical axis, and SG11 is an on-axis distance from an intersection of an object side surface of the first lens and the optical axis to the object side surface in a non-effective radial area of the first lens.

According to an exemplary implementation of the present application, the optical imaging lens assembly satisfies: 5.0<(d0s+D0m)/EPD<5.75, where d0s is an inner diameter of an object side end surface of the lens barrel, EPD is an entrance pupil diameter of the optical imaging lens assembly, and D0m is an outer diameter of an image side end surface of the lens barrel.

According to an exemplary implementation of the present application, the optical imaging lens assembly satisfies: 1.4<d0m/d0s<1.55, where d0m is an inner diameter of the image side end surface of the lens barrel, and d0s is an inner diameter of the object side end surface of the lens barrel.

According to an exemplary implementation of the present application, the first supporting member is in contact with an object side surface of the second lens; the second supporting member is in contact with an object side surface of the third lens; the third supporting member is in contact with an object side surface of the fourth lens; the fourth supporting member is in contact with an object side surface of the fifth lens; and the fifth supporting member is in contact with an object side surface of the sixth lens.

According to an exemplary implementation of the present application, the first lens has a positive refractive power, and has a convex object side surface and a concave image side surface. The second lens has a negative refractive power, and has a convex object side surface and a concave image side surface. The third lens has a positive refractive power, and has a convex object side surface. The fourth lens has a negative refractive power, and has a convex object side surface and a concave image side surface. The fifth lens has a positive refractive power, and has a concave object side surface and a convex image side surface. The sixth lens has a positive refractive power, and has a convex object side surface and a concave image side surface. The seventh lens has a negative refractive power, and has a convex object side surface and a concave image side surface.

Another aspect of the present application provides an optical imaging lens assembly, comprising a lens barrel and a lens group and a supporting member group accommodated in the lens barrel, wherein the number of lenses having refractive powers in the lens group is seven, and the lens group comprises a first lens having a positive refractive power, a second lens having a negative refractive power, a third lens having a positive refractive power, a fourth lens having a negative refractive power, a fifth lens having a positive refractive power, a sixth lens having a positive refractive power and a seventh lens having a negative refractive power, which are arranged in order from an object side to an image side along an optical axis, wherein a difference between maximum outer diameters of the fourth lens and the fifth lens is smaller than a difference between maximum outer diameters of the fifth lens and the sixth lens; the supporting member group comprises a third supporting member, a fourth supporting member and a fifth supporting member, wherein the third supporting member is disposed between the third lens and the fourth lens and in contact with an image side surface of the third lens, the fourth supporting member is disposed between the fourth lens and the fifth lens and in contact with an image side surface of the fourth lens, and the fifth supporting member is disposed between the fifth lens and the sixth lens and in contact with an image side surface of the fifth lens; and the optical imaging lens assembly satisfies: 3.7<f5/d5s<5.6; and 7.75<EP45/(CP4+CP5)<11.55, where f5 is an effective focal length of the fifth lens, d5s is an inner diameter of an object side surface of the fifth supporting member, EP45 is a distance from an image side surface of the fourth supporting member to an object side surface of the fifth supporting member along the direction of the optical axis, CP4 is a maximum thickness of the fourth supporting member, and CP5 is a maximum thickness of the fifth supporting member.

In the optical imaging lens assembly provided in the present application, by controlling 1.80<FNO/tan (Semi-FOV)<1.95, it is ensured that the optical imaging lens assembly has a large aperture feature. After light enters the optical imaging lens assembly, the thickness, shape, etc. of the lenses will affect the progression and stability of the light, especially the sudden increase in the radial step difference from the fifth lens to the sixth lens. The fifth lens is a large convex lens with a thin edge and a thick center, and the fourth lens is a lens with a high refractive index. Therefore, by controlling EP45/(CP4+CP5) and CT4/EP34*N4, the edge thickness of the fifth lens and the ratio of the edge thickness to the center thickness of the fourth lens are ensured to be within a certain range, and the optical paths of the lenses are accurately controlled to avoid uneven light emission angles caused by uneven thickness inside the lenses, thereby improving the clarity and resolution of the optical imaging lens assembly. It is helpful to reduce optical losses inside the lenses and improve light transmittance. At the same time, by controlling the edge thicknesses of the fourth lens and the fifth lens within the above range, appropriate tolerance sensitivity is ensured, reducing the influence of the edge thicknesses of the fourth lens and the fifth lens on the peak value and field curvature of the MTF of the optical imaging lens assembly, and improving the MTF performance.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Other features, objects, and advantages of the present application will become more apparent by reading a detailed description of non-restrictive embodiments made with reference to the following drawings. In the drawings:

FIG. 1 shows a structural arrangement diagram of an optical imaging lens assembly of the present application;

FIG. 2 shows a schematic diagram of some parameters of an optical imaging lens assembly of the present application;

FIG. 3 shows a schematic structural diagram of an optical imaging lens assembly according to Embodiment 1 of the present application;

FIG. 4 shows a schematic structural diagram of an optical imaging lens assembly according to Embodiment 2 of the present application;

FIG. 5 shows an astigmatism curve (A1), a distortion curve (B1), and a lateral color curve (C1) of the optical imaging lens assemblies according to Embodiments 1 and 2 of the present application;

FIG. 6 shows a schematic structural diagram of an optical imaging lens assembly according to Embodiment 3 of the present application;

FIG. 7 shows a schematic structural diagram of an optical imaging lens assembly according to Embodiment 4 of the present application;

FIG. 8 shows an astigmatism curve (A2), a distortion curve (B2), and a lateral color curve (C2) of the optical imaging lens assemblies according to Embodiments 3 and 4 of the present application;

FIG. 9 shows a schematic structural diagram of an optical imaging lens assembly according to Embodiment 5 of the present application;

FIG. 10 shows a schematic structural diagram of an optical imaging lens assembly according to Embodiment 6 of the present application;

FIG. 11 shows an astigmatism curve (A3), a distortion curve (B3), and a lateral color curve (C3) of the optical imaging lens assemblies according to Embodiments 5 and 6 of the present application;

FIG. 12 shows a schematic structural diagram of an optical imaging lens assembly according to Embodiment 7 of the present application;

FIG. 13 shows a schematic structural diagram of an optical imaging lens assembly according to Embodiment 8 of the present application;

FIG. 14 shows an astigmatism curve (A4), a distortion curve (B4), and a lateral color curve (C4) of the optical imaging lens assemblies according to Embodiments 7 and 8 of the present application;

FIG. 15 shows tolerance sensitivity curves of an optical imaging lens assembly of the present application when FNO/tan (Semi-FOV)=1.92, EP45/(CP4+CP5)=9.84 and CT4/EP34*N4=0.92 are satisfied;

FIG. 16 shows modulation transfer function curves of an optical imaging lens assembly of the present application when FNO/tan (Semi-FOV)=1.92, EP45/(CP4+CP5)=9.84 and CT4/EP34*N4=0.92 are satisfied;

FIG. 17 shows tolerance sensitivity curves of an optical imaging lens assembly of the present application when FNO/tan (Semi-FOV)=1.92, EP45/(CP4+CP5)=11.6 and CT4/EP34*N4=1.1 are satisfied;

FIG. 18 shows modulation transfer function curves of an optical imaging lens assembly of the when FNO/tan (Semi-FOV)=1.92, present application EP45/(CP4+CP5)=11.6 and CT4/EP34*N4=1.1 are satisfied;

FIG. 19 shows tolerance sensitivity curves of an optical imaging lens assembly of the present application when FNO/tan (Semi-FOV)=1.92, EP45/(CP4+CP5)=7.5 and CT4/EP34*N4=0.68 are satisfied; and

FIG. 20 shows modulation transfer function curves of an optical imaging lens assembly of the when present application FNO/tan (Semi-FOV)=1.92, EP45/(CP4+CP5)=7.5 and CT4/EP34*N4=0.68 are satisfied.

### DETAILED DESCRIPTION

In order to better understand the present application, various aspects of the present application will be described in more detail with reference to the drawings. It should be understood that the detailed description is merely description of exemplary implementations of the present application, and does not limit the scope of the present application in any way. Throughout the description, the same reference signs refer to the same elements.

It should be noted that in the present description, the expressions of “first”, “second”, “third” etc. are only used to distinguish one feature from another feature, and do not indicate any limitation on the feature. Therefore, without departing from the teachings of the present application, a first lens discussed below may also be referred to as a second lens or a third lens.

In the drawings, for convenience of explanation, the thickness, size, and shape of a lens have been slightly exaggerated. Specifically, the shapes of spherical or aspherical surfaces shown in the drawings are shown by way of example. That is, the shapes of the spherical or aspheric surfaces are not limited to those shown in the drawings. The drawings are only examples and are not drawn strictly to scale.

Herein, if a lens surface is convex and the position of the convex surface is not defined, then it means that the lens surface is convex at least in a paraxial region; and if a lens surface is concave and the position of the concave surface is not defined, then it means that the lens surface is concave at least in a paraxial region. The paraxial region refers to a region near an optical axis. A surface of each lens closest to a subject (=an object to be captured) is referred as an object side surface of the lens, and a surface of each lens closest to an imaging plane is referred as an image side surface of the lens.

It should also be understood that the terms “comprise” and/or “have” when used in this specification, just indicate the existence of stated features, elements and/or components, but do not exclude the presence or addition of one or more other features, elements, components and/or combinations thereof. In addition, when an implementation of the present application is described, “may” is used to indicate “one or more implementations of the present application”. Also, the term “exemplary” is intended to refer to an example or illustration.

Unless otherwise defined, all terms (including technical and scientific terms) used herein have the same meanings as commonly understood by those of ordinary skill in the art to which the present application belongs. It should also be understood that the terms (such as those defined in commonly used dictionaries) should be interpreted to have meanings consistent with their meanings in the context of the relevant art and will not be interpreted in an idealized or overly significance formal sense unless it is clearly defined herein.

It should be noted that, in the case of no conflict, the embodiments in the present application and the features in the embodiments may be combined with each other. The following embodiments only represent several implementations of the present application, and the description thereof is relatively specific and detailed, but it should not be construed as limiting the scope of the patent of the present application. It should be pointed out that for a person skilled in the art, several modifications and improvements, which all belong to the scope of protection of the present application, can be made without departing from the concept of the present application. For example, the lens groups, lens barrels and supporting member groups in the various embodiments of the present application can be combined arbitrarily, and are not limited to the lens group in an embodiment being able to be combined only with the lens barrel, supporting member group, etc. of that embodiment.

The present application will be described in detail below in conjunction with embodiments with reference to the drawings.

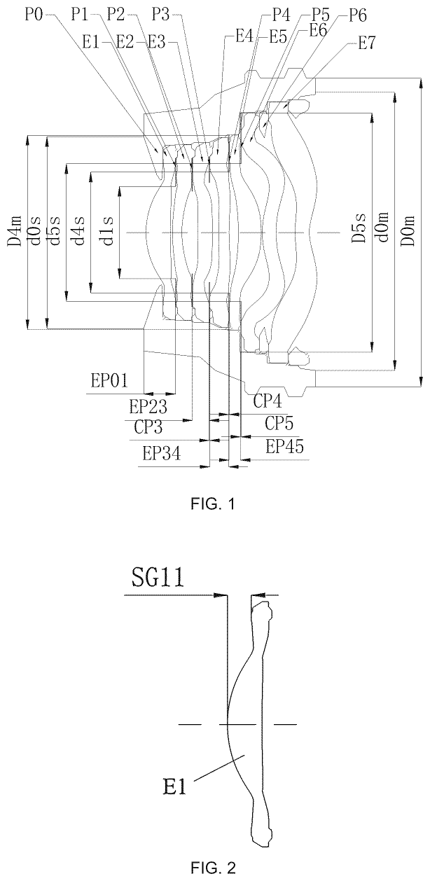

FIG. 1 illustratively shows a structural arrangement diagram and some parameters of an optical imaging lens assembly of the present application, and FIG. 2 illustratively shows a schematic diagram of some parameters of an optical imaging lens assembly of the present application, so as to facilitate a better understanding of the present application. As shown in FIG. 1, d0s is the inner diameter of an object side end surface of a lens barrel; d0m is the inner diameter of an image side end surface of the lens barrel; D0m is the outer diameter of the image side end surface of the lens barrel; d1s is the inner diameter of an object side surface of a first supporting member; d4s is the inner diameter of an object side surface of a fourth supporting member; D4m is the outer diameter of an image side surface of the fourth supporting member; d5s is the inner diameter of an object side surface of a fifth supporting member; D5s is the outer diameter of the object side surface of the fifth supporting member; EP01 is the distance between the object side end surface of the lens barrel and the object side surface of the first supporting member along an optical axis direction; EP23 is the distance from an image side surface of a second supporting member to an object side surface of a third supporting member along the optical axis direction; EP34 is the distance from the image side surface of the third supporting member to an object side surface of a fourth supporting member along the optical axis direction, EP45 is the distance from an image side surface of the fourth supporting member to the object side surface of the fifth supporting member along the optical axis direction; CP3 is the maximum thickness of the third supporting member; CP4 is the maximum thickness of the fourth supporting member; CP5 is the maximum thickness of the fifth supporting member; P0 is the lens barrel, P1 is the first supporting member, P2 is the second supporting member, P3 is the third supporting member, P4 is the fourth supporting member, P5 is the fifth supporting member, and P6 is the sixth supporting member; and E1 is a first lens, E2 is a second lens, E3 is a third lens, E4 is a fourth lens, E5 is a fifth lens, E6 is a sixth lens, and E7 is a seventh lens. As shown in FIG. 2, SG11 is an on-axis distance from the intersection of the object side surface of the first lens and the optical axis to a non-effective radial section of the object side surface of the first lens. It should be noted that the non-effective radial section of the object side surface of the first lens here refers to a position closest to the object side in the non-effective radial area of the object side surface of the first lens.

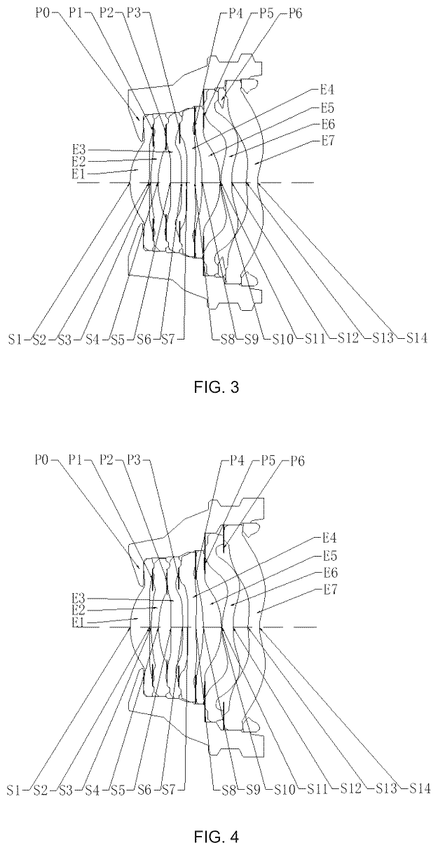

With reference to FIGS. 3, 4, 6, 7, 9, 10, 12 and 13, a first aspect of the present application provides an optical imaging lens assembly. The optical imaging lens assembly includes a seven-element lens group, and the seven-element lens group may include a first lens, a second lens, a third lens, a fourth lens, a fifth lens, a sixth lens and a seventh lens having refractive powers, which are arranged in order from an object side to an image side along an optical axis. Each lens has at least an object side surface facing the side of a captured object and an image side surface facing the side of an imaging plane. Each lens has an effective radial area through which light can pass, and a non-effective radial area surrounding the effective radial area, through which light cannot pass. Among the first lens to the seventh lens, any two adjacent lenses may have a spacing distance on the optical axis, and the spacing distance may be an air spacing.

In an exemplary implementation, the first lens has a positive refractive power. The second lens has a negative refractive power. The third lens has a positive refractive power. The fourth lens has a negative refractive power. The fifth lens has a positive refractive power. The sixth lens has a positive refractive power. The seventh lens has a negative focal power.

In an exemplary implementation, the first lens has a convex object side surface and a concave image side surface. The second lens has a convex object side surface and a concave image side surface. The third lens has a convex object side surface and a concave or convex image side surface. The fourth lens has a convex object side surface and a concave image side surface. The fifth lens has a concave object side surface and a convex image side surface. The sixth lens has a convex object side surface and a concave image side surface. The seventh lens has a convex object side surface and a concave image side surface.

In an exemplary implementation, the optical imaging lens assembly further includes a lens barrel. The lens group and a supporting member group are disposed in the lens barrel. The lens barrel includes an object side end surface, an image side end surface, an outer annular surface, and an inner annular surface, wherein the end surface of the lens barrel closest to the object side is the object side end surface of the lens barrel, and the end surface of the lens barrel closest to the image side is the image side end surface of the lens barrel; in a direction perpendicular to the optical axis, the surface of the lens barrel farthest from the optical axis is the outer annular surface, and the surface of the lens barrel closest to the optical axis is the inner annular surface.

In an exemplary implementation, the optical imaging lens assembly may further include a diaphragm for limiting a light beam. The diaphragm is advantageous to restrain light entering the optical lens assembly, reducing the maximum clear aperture of the optical lens assembly, and reducing the assembling sensitivity of the system, so as to further improve the imaging quality of the optical lens assembly. It should be noted that the diaphragm may be disposed between any lenses or on one side of any lens according to actual needs.

In an exemplary implementation, the optical imaging lens assembly further includes a supporting member group. The supporting member group may include at least one supporting member, which is disposed between the lenses and located in the non-effective radial area of a lens. It should be understood that the present application does not specifically limit the number of supporting members, at least one supporting member is disposed between any two adjacent lenses, and the entire optical imaging lens assembly may also include any number of supporting members. The supporting member helps the optical imaging lens assembly to intercept excess refractive and reflective light paths, reduce stray light and ghosting, thereby improving imaging quality. The shapes of the respective supporting members may be the same or different, as long as they can play corresponding functions.

In an exemplary implementation, the supporting member group includes a first supporting member, a second supporting member, a third supporting member, a fourth supporting member, a fifth supporting member and a sixth supporting member. The first supporting member is disposed between the first lens and the second lens, is at least partially in contact with the image side surface of the first lens, and is at least partially in contact with the object side surface of the second lens. The second supporting member is disposed between the second lens and the third lens, is at least partially in contact with the image side surface of the second lens, and is at least partially in contact with the object side surface of the third lens. The third supporting member is disposed between the third lens and the fourth lens, is at least partially in contact with the image side surface of the third lens, and is at least partially in contact with the object side surface of the fourth lens. The fourth supporting member is disposed between the fourth lens and the fifth lens, is at least partially in contact with the image side surface of the fourth lens, and is at least partially in contact with the object side surface of the fifth lens. The fifth supporting member is disposed between the fifth lens and the sixth lens, is at least partially in contact with the image side surface of the fifth lens, and is at least partially in contact with the object side surface of the sixth lens. The sixth supporting member is disposed between the sixth lens and the seventh lens, is at least partially in contact with the image side surface of the sixth lens, and is at least partially in contact with the object side surface of the seventh lens.

In an exemplary implementation, the difference between maximum outer diameters of the fourth lens and the fifth lens is smaller than the difference between maximum outer diameters of the fifth lens and the sixth lens, and the optical imaging lens assembly satisfies: 1.80<FNO/tan (Semi-FOV)<1.95, 7.75<EP45/(CP4+CP5)<11.55 and 0.7<CT4/EP34*N4<0.96, where FNO is the f-number of the optical imaging lens assembly, EP45 is the distance from the image side surface of the fourth supporting member to the object side surface of the fifth supporting member along the direction of the optical axis, CP4 is the maximum thickness of the fourth supporting member, CP5 is the maximum thickness of the fifth supporting member, CT4 is the center thickness of the fourth lens on the optical axis, EP34 is the distance from the image side surface of the third supporting member to the object side surface of the fourth supporting member along the direction of the optical axis, N4 is the refractive index of the fourth lens, and Semi-FOV is half of the maximum field-of-view angle of the optical imaging lens assembly. It should be noted that the maximum outer diameter of a lens refers to a position where the outer annular surface of the lens is parallel to the optical axis.

In the present application, by controlling 1.80<FNO/tan (Semi-FOV)<1.95, it is ensured that the optical imaging lens assembly has a large aperture feature. After light enters the optical imaging lens assembly, the thickness, shape, etc. of the lenses will affect the progression and stability of the light, especially the sudden increase in the radial step difference from the fifth lens to the sixth lens. The fifth lens is a large convex lens with a thin edge and a thick center, and the fourth lens is a lens with a high refractive index. Therefore, by controlling EP45/(CP4+CP5) and CT4/EP34*N4, the edge thickness of the fifth lens and the ratio of the edge thickness to the center thickness of the fourth lens are ensured to be within a certain range, and the optical paths of the lenses are accurately controlled to avoid uneven light emission angles caused by uneven thickness inside the lenses, thereby improving the clarity and resolution of the optical imaging lens assembly. It is helpful to reduce optical losses inside the lenses and improve light transmittance. At the same time, by controlling the edge thicknesses of the fourth lens and the fifth lens within the above range, appropriate tolerance sensitivity is ensured, reducing the influence of the edge thicknesses of the fourth lens and the fifth lens on the peak value and field curvature of the MTF of the optical imaging lens assembly, and improving the MTF performance.

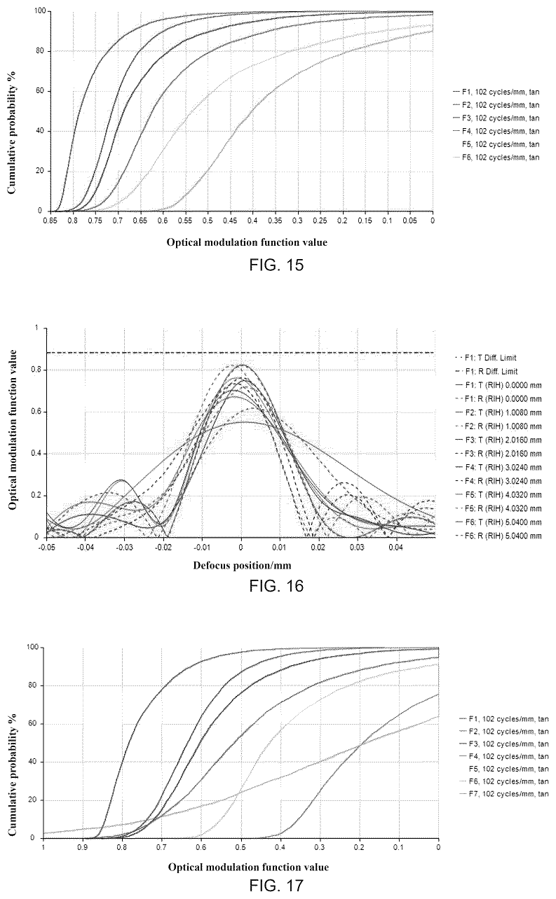

FIGS. 15 and 16 shows tolerance sensitivity curves and modulation transfer function curves of an optical imaging lens assembly of the present application when FNO/tan (Semi-FOV)=1.92, EP45/(CP4+CP5)=9.84 and CT4/EP34*N4=0.92 are satisfied, respectively;

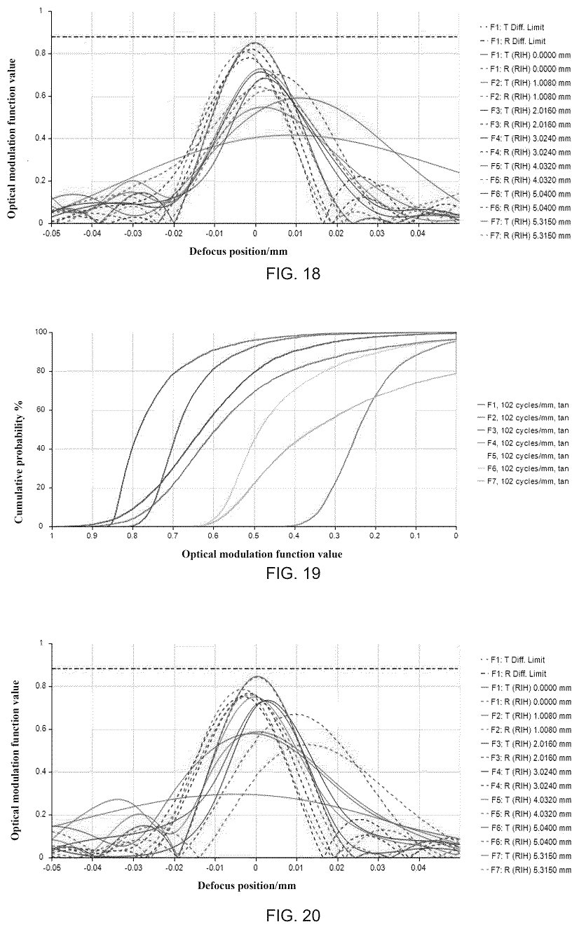

FIGS. 17 and 18 shows tolerance sensitivity curves and modulation transfer function curves of an optical imaging lens assembly of the present application when FNO/tan (Semi-FOV)=1.92, EP45/(CP4+CP5)=11.6 and CT4/EP34*N4=1.1 are satisfied, respectively;

FIGS. 19 and 20 shows tolerance sensitivity curves and modulation transfer function curves of an optical imaging lens assembly of the present application when FNO/tan (Semi-FOV)=1.92, EP45/(CP4+CP5)=7.5 and CT4/EP34*N4=0.68 are satisfied, respectively.

The optical imaging lens assembly according to FIGS. 15 and 16 satisfies the ranges defined by the conditional expressions of FNO/tan (Semi-FOV)=1.92, EP45/(CP4+CP5) and CT4/EP34*N4 of the present application. On the premise of ensuring that the optical imaging lens assembly has a large aperture, the optical paths of the lenses can be accurately controlled to avoid uneven light emission angles caused by uneven thickness inside the lenses, thereby improving the clarity and resolution of the optical imaging lens assembly. It is helpful to reduce optical losses inside the lenses and improve light transmittance. At the same time, by controlling the edge thicknesses of the fourth lens and the fifth lens within the above range, appropriate tolerance sensitivity is ensured, reducing the influence of the edge thicknesses of the fourth lens and the fifth lens on the peak value and field curvature of the MTF of the optical imaging lens assembly. As can be seen from the figures, the defocus curve is relatively concentrated, the MTF peak is relatively high, and the tolerance sensitivity is effectively reduced.

The optical imaging lens assembly according to FIGS. 17 and 18 exceeds the ranges defined by the conditional expressions of EP45/(CP4+CP5) and CT4/EP34*N4 of the present application. On the premise that the optical imaging lens assembly has a large aperture, since the distance between the fourth supporting member and the fifth supporting member along the direction of the optical axis is too large, light passing through the fifth lens becomes steeper. As can be seen from the figures, the MTF peak value decreases and the tolerance sensitivity becomes worse. Moreover, the distance from the image side surface of the third supporting member to the object side surface of the fourth supporting member along the direction of the optical axis becomes smaller, causing the optical imaging lens assembly to be more sensitive to eccentricity and tilt, increasing the overall field curvature and affecting the imaging effect.

The optical imaging lens assembly according to FIGS. 19 and 20 exceeds the ranges defined by the conditional expressions of EP45/(CP4+CP5) and CT4/EP34*N4 of the present application. On the premise that the optical imaging lens assembly has a large aperture, since the distance between the fourth supporting member and the fifth supporting member along the direction of the optical axis is too small, the edge surface profile sensitivity passing through the fifth lens increases and the edge field-of-view peak decreases. At the same time, the distance from the image side surface of the third supporting member to the object side surface of the fourth supporting member along the direction of the optical axis becomes larger, resulting in a decrease in the sensitivity of the optical imaging lens assembly to eccentricity and tilt. However, the peripheral light propagation becomes steeper, and the edge field-of-view peak decreases significantly, affecting the imaging effect.

In an exemplary implementation, the optical imaging lens assembly satisfies: 3.1<d0s/(EP01+CT1)<3.75, where d0s is the inner diameter of the object side end surface of the lens barrel, EP01 is the distance between the object side end surface of the lens barrel and the object side surface of the first supporting member along the direction of the optical axis, and CT1 is the center thickness of the first lens on the optical axis. By controlling the above conditions, it is helpful to prevent the highest point of the object side surface of the first lens from protruding from the object side end surface of the lens barrel, prevent the object side surface of the first lens from being scratched during assembly or transportation of the finished product, and thus reduce the risk of reduced imaging clarity of the optical imaging lens assembly.

In an exemplary implementation, the optical imaging lens assembly satisfies: 0.75<EP23/CT3<1.2, where EP23 is the distance from the image side surface of the second supporting member to the object side surface of the third supporting member along the direction of the optical axis, and CT3 is the center thickness of the third lens on the optical axis. By controlling the above conditions, it is helpful to make the overall structure of the third lens uniform, avoid the risk of molding defects caused by the excessively large difference between the edge thickness and the middle thickness, especially avoid the serious edge deformation during demolding of the third lens which reduces the roundness of the object side surface of the third lens at a snap-in position, and further reduce the risk of MTF performance degradation after assembly.

In an exemplary implementation, the optical imaging lens assembly satisfies: 0.45<EP45/CT5<0.7, where EP45 is the distance from the image side surface of the fourth supporting member to the object side surface of the fifth supporting member along the direction of the optical axis, and CT3 is the center thickness of the fifth lens on the optical axis. By controlling the above conditions, it is helpful to avoid the risk of weld marks, air entrapment, demolding deformation or the like of the fifth lens during molding due to the excessively large ratio of the edge thickness to the middle thickness of the fifth lens, thereby reducing the risk of defects in the surface profile of the fifth lens and improving the effectiveness and authenticity of the final imaging of the optical imaging lens assembly.

In an exemplary implementation, the optical imaging lens assembly satisfies: 3.7<f5/d5s<5.6, where f5 is the effective focal length of the fifth lens, and d5s is the inner diameter of the object side surface of the fifth supporting member. By controlling the above conditions, it is helpful to control light passing through the fifth lens to satisfy the formation of complementary refractive powers while ensuring the overall machinability/processability of the fifth lens. At the same time, controlling the inner diameter of the object side surface of the fifth supporting member can avoid the risk of intercepting effective imaging light due to a too small inner diameter and thereby reducing the effectiveness of imaging; and a too large inner diameter may cause light leakage or fail to effectively intercept ineffective imaging light, thereby forming noise on the image plane and reducing the authenticity of the entire image plane.

In an exemplary implementation, the optical imaging lens assembly satisfies: 0.55<(R10−R9)/d5s<1.05, where R9 is the radius of curvature of the object side surface of the fifth lens, R10 is the radius of curvature of the image side surface of the fifth lens, and d5s is the inner diameter of the object side surface of the fifth supporting member. By controlling the above conditions, it is helpful to avoid the risk of retroflexed edge curvature of the image side surface edge of the fifth lens, and further avoid the risk of stray light generated by that the gap between the inner diameter of the object side surface of the fifth supporting member and the edge of the effective radial area of the fifth lens is too large so that the internal reflection light of the fifth lens penetrates through the gap to an image plane.

In an exemplary implementation, the optical imaging lens assembly satisfies: 0.15<(D5s−D4m)/d4s<0.5, where D5s is the outer diameter of the object side surface of the fifth supporting member, D4m is the outer diameter of the image side surface of the fourth supporting member, and d4s is the inner diameter of the object side surface of the fourth supporting member. By controlling the above conditions, it is helpful to ensure that the wall thickness of the lens barrel at the bearing and supporting position of the fifth lens is uniformly transitioned, avoid the risk of shrinkage marks, air entrapment and other molding defects caused by a sudden change in the thickness of the lens barrel, and improve the stability and strength of the overall assembly of the lenses.

In an exemplary implementation, the optical imaging lens assembly satisfies: 10.35<T34/CP3<16.6, where T34 is an air gap between the third lens and the fourth lens on the optical axis, and CP3 is the maximum thickness of the third supporting member. By controlling the above conditions, it is helpful to ensure that the distance between the effective aperture edge of the image side surface of the third lens and the effective aperture edge of the object side surface of the fourth lens will not be too large or too small after the third supporting member is disposed, which can prevent ineffective light from passing through the lens to form an image on the imaging plane, and can also prevent the inner side of the third supporting member from separately interfering with the effective aperture edge of the image side surface of the third lens and the effective aperture edge of the object side surface of the fourth lens, thereby improving the imaging quality and authenticity of the optical imaging lens assembly.

In an exemplary implementation, the supporting member group further includes a first supporting member, and the first supporting member is disposed between the first lens and the second lens and in contact with the image side surface of the first lens; and the optical imaging lens assembly satisfies: 0.3<f1/(R1+R2)<0.5 and 1.95<d0s/d1s<2.1, where f1 is the effective focal length of the first lens, R1 is the radius of curvature of the object side surface of the first lens, R2 is the radius of curvature of the image side surface of the first lens, d0s is the inner diameter of the object side end surface of the lens barrel, and d1s is the inner diameter of the object side surface of the first supporting member. By controlling the above conditions, it is helpful to avoid the situation where the middle thickness of the first lens is too large and the lens edge diameter is too small, and the probability of the weld mark generated during the molding of the first lens remaining in the effective radial area is minimized, and the clarity of the imaging is maximized to obtain high-quality imaging. As an example, it applies: 0.3<f1/(R1+R2)<0.45.

In an exemplary implementation, the optical imaging lens assembly satisfies: 1.65<EP01/SG11<1.9, where EP01 is the distance between the object side end surface of the lens barrel and the object side surface of the first supporting member along the direction of the optical axis, and SG11 is the on-axis distance from the intersection of the object side surface of the first lens and the optical axis to the non-effective radial section of the object side surface of the first lens. By controlling the above conditions, it helps to ensure that the thickness of the aperture diaphragm at the front end of the lens barrel is not too thick or too thin. Although the thickness being too thick ensures the assembly strength of the front end of the lens barrel, the front end protrudes too much and there is a risk of blocking the light at the edge of the maximum field-of-view angle, which will cause the imaging region to be reduced. Although the thickness being too thin ensures that the imaging light within the field-of-view angle is not blocked, the front end of the lens barrel is too thin and has low strength, and it is very easy to deform or crack during the lens assembly pressure process, affecting the imaging quality of the optical imaging lens assembly.

In an exemplary implementation, the optical imaging lens assembly satisfies: 5.0<(d0s+D0m)/EPD<5.75, where d0s is the inner diameter of the object side end surface of the lens barrel, EPD is the entrance pupil diameter of the optical imaging lens assembly, and D0m is the outer diameter of the image side end surface of the lens barrel. By controlling the above conditions, for an optical imaging lens assembly with a large field-of-view angle, it is helpful to avoid the risk that the actual field-of-view angle is lower than the theoretical design value too much due to the ratio of (d0s+D0m)/EPD being too small and therefore that the main ray incident angle (CRA) and relative illumination (RI) of the imaging are disadvantageously affected. At the same time, it is also possible to avoid the risk that the front end head of the lens barrel is too large due to the ratio of (d0s+D0m)/EPD being too large, and therefore that the lens assembly, upon being matched with a module and being fit together in a device, occupies a large space or interferes with other parts of the device.

In an exemplary implementation, the optical imaging lens assembly satisfies: 1.4<d0m/d0s<1.55, where d0m is the inner diameter of the image side end surface of the lens barrel, and d0s is the inner diameter of the object side end surface of the lens barrel. By controlling the above conditions, it is helpful to assemble the lenses and design the bearing and supporting fixture. At the same time, the restriction of the inner diameter of the image side end surface of the lens barrel is very beneficial to the extinction of the ineffective imaging light of the last lens on the imaging surface side, which can effectively avoid the generation of stray light or light leakage that affects the imaging quality.

In an exemplary implementation, the first supporting member is in contact with an object side surface of the second lens; the second supporting member is in contact with an object side surface of the third lens; the third supporting member is in contact with an object side surface of the fourth lens; the fourth supporting member is in contact with an object side surface of the fifth lens; and the fifth supporting member is in contact with an object side surface of the sixth lens. The image side surface of each supporting member in the supporting member group being at least partially in contact with the object side surface of the respective next lens is to ensure that each of the supporting members is fixed within the range allowed by the lens assembly design, and avoid the effective imaging light being intercepted or the non-imaging light penetrating to the imaging plane due to the movement of the supporting member in the optical axis direction, and therefore affecting the imaging quality, RI, CRA and other optical properties.

Another aspect of the present application provides an optical imaging lens assembly, including a lens barrel and a lens group and a supporting member group accommodated in the lens barrel, wherein the number of lenses in the lens group is seven, and the lens group includes a first lens having a positive refractive power, a second lens having a negative refractive power, a third lens having a positive refractive power, a fourth lens having a negative refractive power, a fifth lens having a positive refractive power, a sixth lens having a positive refractive power and a seventh lens having a negative refractive power, which are arranged in order from an object side to an image side along an optical axis, wherein a difference between maximum outer diameters of the fourth lens and the fifth lens is smaller than a difference between maximum outer diameters of the fifth lens and the sixth lens; the supporting member group includes a third supporting member, a fourth supporting member and a fifth supporting member, wherein the third supporting member is disposed between the third lens and the fourth lens and in contact with an image side surface of the third lens, the fourth supporting member is disposed between the fourth lens and the fifth lens and in contact with an image side surface of the fourth lens, and the fifth supporting member is disposed between the fifth lens and the sixth lens and in contact with an image side surface of the fifth lens; and the optical imaging lens assembly satisfies: 3.7<f5/d5s<5.6; and 7.75<EP45/(CP4+CP5)<11.55, where f5 is an effective focal length of the fifth lens, d5s is an inner diameter of an object side surface of the fifth supporting member, EP45 is a distance from an image side surface of the fourth supporting member to an object side surface of the fifth supporting member along the direction of the optical axis, CP4 is a maximum thickness of the fourth supporting member, and CP5 is a maximum thickness of the fifth supporting member.

In the present application, by controlling the above conditions, it is helpful to satisfy the front and rear complementarity of refractive powers of the respective lenses in the lens assembly and ensure that the lenses have good machinability/processability. Each of the supporting members is in contact with the object side surface of a lens after being disposed, which is to avoid the supporting members from moving in the optical axis direction, causing the inner diameter of the object side surface of the respective supporting members to excessively intercept light or allow the light to penetrate to the imaging plane, resulting in the imaged picture's ability to restore the real object far below the design requirements, or causing non-effective imaging light to penetrate to the imaging plane to form an image, resulting in serious stray light on the image plane, and reducing the authenticity and effectiveness of imaging.

It should be understood by those skilled in the art that the number of lenses and supporting members forming the optical imaging lens assembly can be changed without departing from the technical solutions claimed in the present application, to obtain various results and advantages described in the specification.

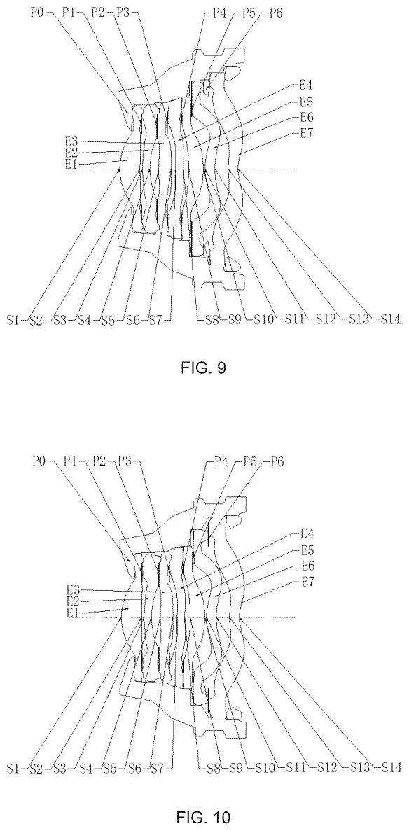

Specific embodiments of the optical imaging lens assembly applicable to the above-mentioned implementations will be further described below with reference to the drawings. Specifically, the optical imaging lens assemblies according to Embodiments 1 and 2 of the present application will be described with reference to FIGS. 3 to 5; the optical imaging lens assemblies according to Embodiments 3 and 4 of the present application will be described with reference to FIGS. 6 to 8; the optical imaging lens assemblies according to Embodiments 5 and 6 of the present application will be described with reference to FIGS. 9 to 11; and the optical imaging lens assemblies according to Embodiments 7 and 8 of the present application will be described with reference to FIGS. 12 to 14.

### Embodiment 1

FIG. 3 shows a schematic structural diagram of the optical imaging lens assembly according to Embodiment 1 of the present application. As shown in FIG. 3, the optical imaging lens assembly includes a lens barrel P0, and a seven-element lens group and a supporting member group disposed in the lens barrel P0. The seven-element lens group includes, in order from an object side to an image side along an optical axis: a first lens E1, a second lens E2, a third lens E3, a fourth lens E4, a fifth lens E5, a sixth lens E6, and a seventh lens E7. A diaphragm STO (not shown) is disposed on the object side of the first lens E1.

The first lens E1 has a positive refractive power, and has a convex object side surface S1 and a concave image side surface S2. The second lens E2 has a negative refractive power, and has a convex object side surface S3 and a concave image side surface S4. The third lens E3 has a positive refractive power, and has a convex object side surface S5 and a concave image side surface S6. The fourth lens E4 has a negative refractive power, and has a convex object side surface S7 and a concave image side surface S8. The fifth lens E5 has a positive refractive power, and has a concave object side surface S9 and a convex image side surface S10. The sixth lens E6 has a positive refractive power, and has a convex object side surface S11 and a concave image side surface S12. The seventh lens E7 has a negative refractive power, and has a convex object side surface S13 and a concave image side surface S14. The difference between the maximum outer diameters of the fourth lens and the fifth lens is smaller than the difference between the maximum outer diameters of the fifth lens and the sixth lens.

The supporting member group includes a first supporting member P1, a second supporting member P2, a third supporting member P3, a fourth supporting member P4, a fifth supporting member P5 and a sixth supporting member P6. The first supporting member P1 is disposed between the first lens E1 and the second lens E2, the object side surface of the first supporting member P1 is at least partially in contact with the image side surface S2 of the first lens E1, and the image side surface of the first supporting member P1 is at least partially in contact with the object side surface S3 of the second lens E2. The second supporting member P2 is disposed between the second lens E2 and the third lens E3, the object side surface of the second supporting member P2 is at least partially in contact with the image side surface S4 of the second lens E2, and the image side surface of the second supporting member P2 is at least partially in contact with the object side surface S5 of the third lens E3. The third supporting member P3 is disposed between the third lens E3 and the fourth lens E4, the object side surface of the third supporting member P3 is at least partially in contact with the image side surface S6 of the third lens E3, and the image side surface of the third supporting member P3 is at least partially in contact with the object side surface S7 of the fourth lens E4. The fourth supporting member P4 is disposed between the fourth lens E4 and the fifth lens E5, the object side surface of the fourth supporting member P4 is at least partially in contact with the image side surface S8 of the fourth lens E4, and the image side surface of the fourth supporting member P4 is at least partially in contact with the object side surface S9 of the fifth lens E5. The fifth supporting member P5 is disposed between the fifth lens E5 and the sixth lens E6, the object side surface of the fifth supporting member P5 is at least partially in contact with the image side surface S10 of the fifth lens E5, and the image side surface of the fifth supporting member P5 is at least partially in contact with the object side surface S11 of the sixth lens E6. The sixth supporting member P6 is disposed between the sixth lens E6 and the seventh lens E7, the object side surface of the sixth supporting member P6 is at least partially in contact with the image side surface S12 of the sixth lens E6, and the image side surface of the sixth supporting member P6 is at least partially in contact with the object side surface S13 of the seventh lens E7.

In an example, a filter may be disposed between the seventh lens E7 and an imaging plane S17 (not shown), and the filter has an object side surface S15 (not shown) and an image side surface S16 (not shown). Light from an object passes through the surfaces S1 to S16 in order and is finally imaged on the imaging plane S17.

Table 1 shows a table of basic parameters of the lens group of the optical imaging lens assembly of Embodiment 1, wherein the units of the radius of curvature and thickness/distance are all millimeters (mm).

TABLE 1

| | | Radius of | | Material | | Cone |
|---|---|---|---|---|---|---|
| Surface No. | Surface type | curvature | Thickness | Refractive index | Abbe number | coefficient |
| OBJ | Spherical | Infinite | Infinite | | | |
| STO | Spherical | Infinite | −0.6100 | | | |
| S1 | Aspherical | 2.9267 | 0.9461 | 1.546 | 55.99 | 0.703 |
| S2 | Aspherical | 16.0983 | 0.0766 | | | −6.814 |
| S3 | Aspherical | 5.1235 | 0.3650 | 1.678 | 19.24 | 4.741 |
| S4 | Aspherical | 3.3839 | 0.6147 | | | 0.415 |
| S5 | Aspherical | 21.4078 | 0.5623 | 1.546 | 55.99 | 14.895 |
| S6 | Aspherical | 672.3865 | 0.2441 | | | 17.001 |
| S7 | Aspherical | 8.9263 | 0.4032 | 1.678 | 19.24 | −24.202 |
| S8 | Aspherical | 7.2196 | 0.3624 | | | −6.180 |
| S9 | Aspherical | −9.0183 | 0.8851 | 1.546 | 55.99 | −1.287 |
| S10 | Aspherical | −5.0869 | 0.0400 | | | 1.530 |
| S11 | Aspherical | 3.0767 | 0.5393 | 1.546 | 55.99 | −0.162 |
| S12 | Aspherical | 5.4975 | 0.7295 | | | −0.536 |
| S13 | Aspherical | 3.2867 | 0.5548 | 1.546 | 55.99 | −1.362 |
| S14 | Aspherical | 1.6169 | 1.0581 | | | −4.592 |
| S15 | Spherical | Infinite | 0.2100 | 1.56 | 51.3 | |
| S16 | Spherical | Infinite | 0.1245 | | | |
| S17 | Spherical | Infinite | | | | |

In this embodiment, both the object side surface and image side surface of any one of the first lens E1 to the seventh lens E7 are aspherical, and the surface profile of each aspherical lens can be defined by using but not limited to the following aspherical formula:

$$x = \frac{{ch}^{2}}{1 + \sqrt{1 - ( k + 1 ) {c}^{2} {h}^{2}}} + \sum {Aih}^{1} \qquad ( 1 )$$

where x is a distance vector height from a vertex of the aspherical surface when the aspherical surface is positioned at a height of h along the direction of the optical axis; c is paraxial curvature of the aspherical surface, c=1/R (that is, the paraxial curvature c is the reciprocal of the radius of curvature R in Table 1 above); k is a conic coefficient; and Ai is a correction coefficient of an i-th order of the aspherical surface. Table 2 shows high-order coefficients A4, A6, A8, A10, A12, A14, A16, A18 and A20 of each of the aspherical surfaces S1 to S14 that are applicable in Embodiment 1.

TABLE 2

| Surface No. | A4 | A6 | A8 | A10 | A12 | A14 | A16 | A18 | A20 |
|---|---|---|---|---|---|---|---|---|---|
| S1 | −3.12E−03 | 1.29E−03 | −3.25E−03 | 3.20E−03 | −2.10E−03 | 8.57E−04 | −2.15E−04 | 2.94E−05 | −1.74E−06 |
| S2 | −3.96E−02 | 5.56E−02 | −5.75E−02 | 4.36E−02 | −2.36E−02 | 8.75E−03 | −2.09E−03 | 2.88E−04 | −1.75E−05 |
| S3 | −6.17E−02 | 5.36E−02 | −5.10E−02 | 4.16E−02 | −2.63E−02 | 1.17E−02 | −3.38E−03 | 5.56E−04 | −3.95E−05 |
| S4 | −2.54E−02 | −1.84E−02 | 8.26E−02 | −1.42E−01 | 1.45E−01 | −9.13E−02 | 3.50E−02 | −7.48E−03 | 6.86E−04 |
| S5 | −1.35E−02 | 9.55E−03 | −4.05E−02 | 5.77E−02 | −5.07E−02 | 2.71E−02 | −8.56E−03 | 1.46E−03 | −9.77E−05 |
| S6 | −1.47E−02 | −1.92E−03 | −5.87E−03 | 4.09E−03 | −7.81E−04 | −1.05E−03 | 8.24E−04 | −2.23E−04 | 2.15E−05 |
| S7 | −3.62E−02 | 2.91E−02 | −4.76E−02 | 4.47E−02 | −2.62E−02 | 9.75E−03 | −2.18E−03 | 2.65E−04 | −1.36E−05 |
| S8 | −3.48E−02 | 2.91E−02 | −3.30E−02 | 2.20E−02 | −9.38E−03 | 2.61E−03 | −4.51E−04 | 4.32E−05 | −1.74E−06 |
| S9 | −1.67E−02 | 2.84E−02 | −2.37E−02 | 1.07E−02 | −3.46E−03 | 9.02E−04 | −1.65E−04 | 1.72E−05 | −7.50E−07 |
| S10 | −6.94E−02 | 4.32E−02 | −2.18E−02 | 8.72E−03 | −2.72E−03 | 6.15E−04 | −8.78E−05 | 6.82E−06 | −2.19E−07 |
| S11 | −9.12E−03 | −7.13E−03 | −1.25E−03 | 6.74E−04 | −2.27E−05 | −2.40E−05 | 4.32E−06 | −2.83E−07 | 6.29E−09 |
| S12 | 7.05E−02 | −4.57E−02 | 1.27E−02 | −2.26E−03 | 2.71E−04 | −2.22E−05 | 1.24E−06 | −4.45E−08 | 7.78E−10 |
| S13 | −1.29E−01 | 4.39E−02 | −1.15E−02 | 2.08E−03 | −2.43E−04 | 1.80E−05 | −8.23E−07 | 2.11E−08 | −2.33E−10 |
| S14 | −6.46E−02 | 2.19E−02 | −5.72E−03 | 9.90E−04 | −1.09E−04 | 7.53E−06 | −3.18E−07 | 7.50E−09 | −7.61E−11 |

### Embodiment 2

FIG. 4 shows a schematic structural diagram of the optical imaging lens assembly according to Embodiment 2 of the present application. As shown in FIG. 4, the optical imaging lens assembly includes a lens barrel P0, and a seven-element lens group and a supporting member group disposed in the lens barrel P0. The seven-element lens group includes, in order from an object side to an image side along an optical axis: a first lens E1, a second lens E2, a third lens E3, a fourth lens E4, a fifth lens E5, a sixth lens E6, and a seventh lens E7. A diaphragm STO (not shown) is disposed on the object side of the first lens E1. The supporting member group includes a first supporting member P1, a second supporting member P2, a third supporting member P3, a fourth supporting member P4, a fifth supporting member P5 and a sixth supporting member P6.

The seven-element lens group of the optical imaging lens assembly of this embodiment has the same structure as the seven-element lens group of the optical imaging lens assembly in Embodiment 1, and basic parameters thereof are detailed in Tables 1 and 2 and will not be described in detail.

The difference between this embodiment and Embodiment 1 is that the structure dimensions of the lens barrel P0 and at least some components in the supporting member group are different.

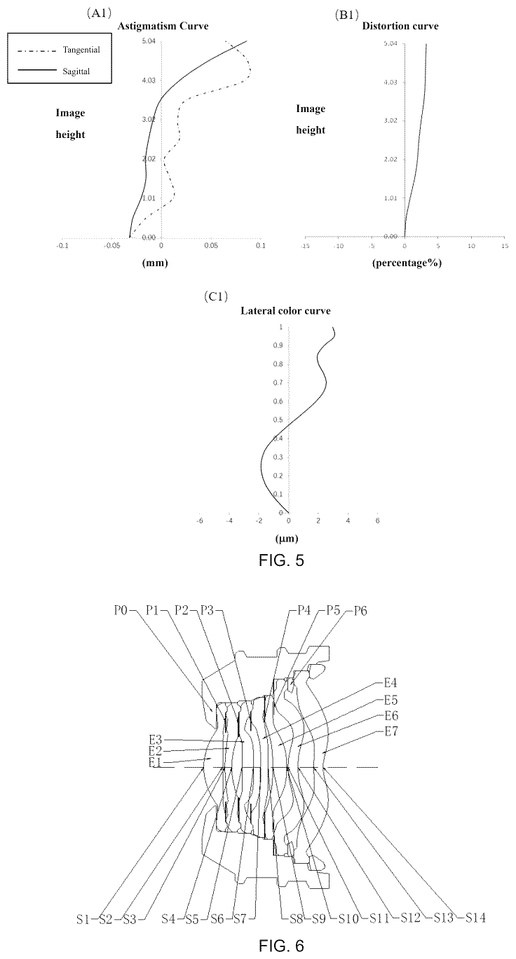

(A1) in FIG. 5 shows an astigmatism curve of the optical imaging lens assemblies of Embodiments 1 and 2, which represents the curvature of the tangential image plane and the curvature of the sagittal image plane. (B1) in FIG. 5 shows a distortion curve of the optical imaging lens assemblies of Embodiments 1 and 2, which represents distortion magnitude values corresponding to different field-of-view angles. (C1) in FIG. 5 shows a lateral color curve of the optical imaging lens assemblies of Embodiments 1 and 2, which represents the deviation of different image heights on the imaging plane after light passes through the lens assembly. According to FIG. 5, it can be seen that the optical imaging lens assemblies provided by Embodiments 1 and 2 can achieve good imaging quality.

### Embodiment 3

FIG. 6 shows a schematic structural diagram of the optical imaging lens assembly according to Embodiment 3 of the present application. As shown in FIG. 6, the optical imaging lens assembly includes a lens barrel P0, and a seven-element lens group and a supporting member group disposed in the lens barrel P0. The seven-element lens group includes, in order from an object side to an image side along an optical axis: a first lens E1, a second lens E2, a third lens E3, a fourth lens E4, a fifth lens E5, a sixth lens E6, and a seventh lens E7. A diaphragm STO (not shown) is disposed on the object side of the first lens E1.

The first lens E1 has a positive refractive power, and has a convex object side surface S1 and a concave image side surface S2. The second lens E2 has a negative refractive power, and has a convex object side surface S3 and a concave image side surface S4. The third lens E3 has a positive focal power, and has a convex object side surface S5 and a convex image side surface S6. The fourth lens E4 has a negative refractive power, and has a convex object side surface S7 and a concave image side surface S8. The fifth lens E5 has a positive refractive power, and has a concave object side surface S9 and a convex image side surface S10. The sixth lens E6 has a positive refractive power, and has a convex object side surface S11 and a concave image side surface S12. The seventh lens E7 has a negative refractive power, and has a convex object side surface S13 and a concave image side surface S14. The difference between the maximum outer diameters of the fourth lens and the fifth lens is smaller than the difference between the maximum outer diameters of the fifth lens and the sixth lens.

The supporting member group includes a first supporting member P1, a second supporting member P2, a third supporting member P3, a fourth supporting member P4, a fifth supporting member P5 and a sixth supporting member P6. The first supporting member P1 is disposed between the first lens E1 and the second lens E2, the object side surface of the first supporting member P1 is at least partially in contact with the image side surface S2 of the first lens E1, and the image side surface of the first supporting member P1 is at least partially in contact with the object side surface S3 of the second lens E2. The second supporting member P2 is disposed between the second lens E2 and the third lens E3, the object side surface of the second supporting member P2 is at least partially in contact with the image side surface S4 of the second lens E2, and the image side surface of the second supporting member P2 is at least partially in contact with the object side surface S5 of the third lens E3. The third supporting member P3 is disposed between the third lens E3 and the fourth lens E4, the object side surface of the third supporting member P3 is in at least partial contact with the image side surface S6 of the third lens E3, and the image side surface of the third supporting member P3 is in at least partial contact with the object side surface S7 of the fourth lens E4. The fourth supporting member P4 is disposed between the fourth lens E4 and the fifth lens E5, the object side surface of the fourth supporting member P4 is at least partially in contact with the image side surface S8 of the fourth lens E4, and the image side surface of the fourth supporting member P4 is at least partially in contact with the object side surface S9 of the fifth lens E5. The fifth supporting member P5 is disposed between the fifth lens E5 and the sixth lens E6, the object side surface of the fifth supporting member P5 is at least partially in contact with the image side surface S10 of the fifth lens E5, and the image side surface of the fifth supporting member P5 is at least partially in contact with the object side surface S11 of the sixth lens E6. The sixth supporting member P6 is disposed between the sixth lens E6 and the seventh lens E7, the object side surface of the sixth supporting member P6 is at least partially in contact with the image side surface S12 of the sixth lens E6, and the image side surface of the sixth supporting member P6 is at least partially in contact with the object side surface S13 of the seventh lens E7.

In an example, a filter may be disposed between the seventh lens E7 and an imaging plane S17 (not shown), and the filter has an object side surface S15 (not shown) and an image side surface S16 (not shown). Light from an object passes through the surfaces S1 to S16 in order and is finally imaged on the imaging plane S17.

Table 3 shows a table of basic parameters of the lens group of the optical imaging lens assembly of Embodiment 3, wherein the units of the radius of curvature and thickness/distance are all millimeters (mm).

TABLE 3

| | | Radius of | | Material | | Cone |
|---|---|---|---|---|---|---|
| Surface No. | Surface type | curvature | Thickness | Refractive index | Abbe number | coefficient |
| OBJ | Spherical | Infinite | Infinite | | | |
| STO | Spherical | Infinite | −0.61 | | | |
| S1 | Aspherical | 2.8699 | 0.9871 | 1.546 | 55.99 | 0.615 |
| S2 | Aspherical | 13.9914 | 0.1205 | | | −37.245 |
| S3 | Aspherical | 5.3924 | 0.3600 | 1.678 | 19.24 | 3.637 |
| S4 | Aspherical | 3.4888 | 0.5390 | | | −0.097 |
| S5 | Aspherical | 16.6646 | 0.5988 | 1.546 | 55.99 | −54.273 |
| S6 | Aspherical | −87.2693 | 0.3643 | | | 50.705 |
| S7 | Aspherical | 49.1848 | 0.3840 | 1.678 | 19.24 | −90.114 |
| S8 | Aspherical | 18.2933 | 0.2574 | | | −10.952 |
| S9 | Aspherical | −8.8184 | 0.7332 | 1.546 | 55.99 | 3.440 |
| S10 | Aspherical | −5.3192 | 0.0600 | | | 0.928 |
| S11 | Aspherical | 3.0231 | 0.5276 | 1.546 | 55.99 | −0.219 |
| S12 | Aspherical | 5.4629 | 0.8102 | | | −1.717 |
| S13 | Aspherical | 3.6318 | 0.5000 | 1.546 | 55.99 | −0.797 |
| S14 | Aspherical | 1.6736 | 1.0404 | | | −4.682 |
| S15 | Spherical | Infinite | 0.2100 | 1.518 | 64.17 | |
| S16 | Spherical | Infinite | 0.1183 | | | |
| S17 | Spherical | Infinite | | | | |

In this embodiment, the object side surface and the image side surface of any lens from the first lens E1 to the seventh lens E7 are both aspherical surfaces, wherein the surface profile of each aspherical surface can be defined by, but not limited to, formula (1) given in Embodiment 1 described above. Table 4 shows high-order coefficients A4, A6, A8, A10, A12, A14, A16, A18 and A20 of each of the aspherical surfaces S1 to S14 that are applicable in Embodiment 3.

TABLE 4

| Surface No. | A4 | A6 | A8 | A10 | A12 | A14 | A16 | A18 | A20 |
|---|---|---|---|---|---|---|---|---|---|
| S1 | −4.37E−03 | 2.71E−03 | −5.59E−03 | 5.69E−03 | −3.74E−03 | 1.52E−03 | −3.74E−04 | 5.11E−05 | −3.02E−06 |
| S2 | −3.01E−02 | 3.05E−02 | −2.35E−02 | 1.42E−02 | −6.78E−03 | 2.43E−03 | −6.01E−04 | 8.83E−05 | −5.72E−06 |
| S3 | −5.49E−02 | 3.53E−02 | −1.92E−02 | 9.36E−03 | −4.36E−03 | 1.86E−03 | −5.91E−04 | 1.11E−04 | −8.89E−06 |
| S4 | −2.79E−02 | 8.41E−03 | 1.37E−02 | −3.08E−02 | 3.47E−02 | −2.40E−02 | 1.01E−02 | −2.38E−03 | 2.41E−04 |
| S5 | −1.07E−02 | −1.61E−02 | 2.49E−02 | −3.47E−02 | 3.09E−02 | −1.85E−02 | 7.06E−03 | −1.54E−03 | 1.48E−04 |
| S6 | −1.19E−02 | −2.27E−02 | 3.49E−02 | −4.04E−02 | 2.88E−02 | −1.32E−02 | 3.80E−03 | −6.22E−04 | 4.38E−05 |
| S7 | −2.90E−02 | 6.94E−04 | −6.67E−03 | 1.46E−02 | −1.30E−02 | 6.20E−03 | −1.62E−03 | 2.20E−04 | −1.23E−05 |
| S8 | −2.65E−02 | 1.45E−03 | −3.69E−03 | 6.43E−03 | −4.69E−03 | 1.86E−03 | −4.04E−04 | 4.56E−05 | −2.08E−06 |
| S9 | −3.00E−03 | 1.16E−02 | −1.94E−02 | 1.54E−02 | −7.69E−03 | 2.44E−03 | −4.64E−04 | 4.76E−05 | −2.02E−06 |
| S10 | −4.99E−02 | 2.42E−02 | −1.10E−02 | 4.88E−03 | −1.86E−03 | 4.98E−04 | −7.99E−05 | 6.73E−06 | −2.30E−07 |
| S11 | −4.51E−03 | −1.65E−02 | 4.49E−03 | −1.06E−03 | 2.25E−04 | −3.32E−05 | 2.61E−06 | −6.80E−08 | −1.18E−09 |
| S12 | 6.58E−02 | −4.44E−02 | 1.33E−02 | −2.65E−03 | 3.66E−04 | −3.50E−05 | 2.26E−06 | −9.02E−08 | 1.65E−09 |
| S13 | −1.29E−01 | 4.01E−02 | −9.32E−03 | 1.54E−03 | −1.68E−04 | 1.17E−05 | −5.00E−07 | 1.20E−08 | −1.25E−10 |
| S14 | −6.58E−02 | 2.11E−02 | −5.01E−03 | 7.76E−04 | −7.46E−05 | 4.34E−06 | −1.44E−07 | 2.39E−09 | −1.29E−11 |

### Embodiment 4

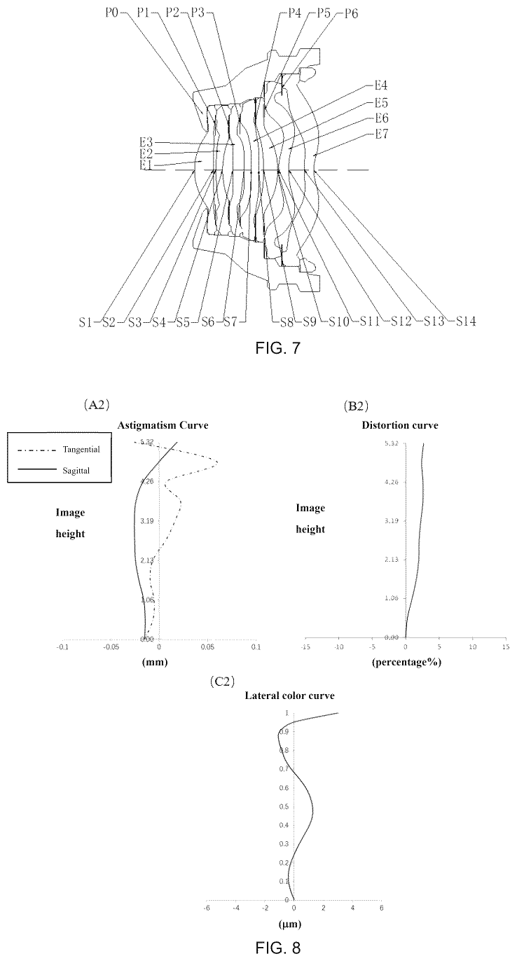

FIG. 7 shows a schematic structural diagram of the optical imaging lens assembly according to Embodiment 4 of the present application. As shown in FIG. 7, the optical imaging lens assembly includes a lens barrel P0, and a seven-element lens group and a supporting member group disposed in the lens barrel P0. The seven-element lens group includes, in order from an object side to an image side along an optical axis: a first lens E1, a second lens E2, a third lens E3, a fourth lens E4, a fifth lens E5, a sixth lens E6, and a seventh lens E7. A diaphragm STO (not shown) is disposed on the object side of the first lens E1. The supporting member group includes a first supporting member P1, a second supporting member P2, a third supporting member P3, a fourth supporting member P4, a fifth supporting member P5 and a sixth supporting member P6.

The seven-element lens group of the optical imaging lens assembly of this embodiment has the same structure as the seven-element lens group of the optical imaging lens assembly in Embodiment 3, and basic parameters thereof are detailed in Tables 3 and 4 and will not be described in detail.

The difference between this embodiment and Embodiment 3 is that the structure dimensions of the lens barrel P0 and at least some components in the supporting member group are different.

(A2) in FIG. 8 shows an astigmatism curve of the optical imaging lens assemblies of Embodiments 3 and 4, which represents the curvature of the tangential image plane and the curvature of the sagittal image plane. (B2) in FIG. 8 shows a distortion curve of the optical imaging lens assemblies of Embodiments 3 and 4, which represents distortion magnitude values corresponding to different field-of-view angles. (C2) in FIG. 8 shows a lateral color curve of the optical imaging lens assemblies of Embodiments 3 and 4, which represents the deviation of different image heights on the imaging plane after light passes through the lens assembly. According to FIG. 8, it can be seen that the optical imaging lens assemblies provided by Embodiments 3 and 4 can achieve good imaging quality.

### Embodiment 5

FIG. 9 shows a schematic structural diagram of the optical imaging lens assembly according to Embodiment 5 of the present application. As shown in FIG. 9, the optical imaging lens assembly includes a lens barrel P0, and a seven-element lens group and a supporting member group disposed in the lens barrel P0. The seven-element lens group includes, in order from an object side to an image side along an optical axis: a first lens E1, a second lens E2, a third lens E3, a fourth lens E4, a fifth lens E5, a sixth lens E6, and a seventh lens E7. A diaphragm STO (not shown) is disposed on the object side of the first lens E1.

The first lens E1 has a positive refractive power, and has a convex object side surface S1 and a concave image side surface S2. The second lens E2 has a negative refractive power, and has a convex object side surface S3 and a concave image side surface S4. The third lens E3 has a positive refractive power, and has a convex object side surface S5 and a concave image side surface S6. The fourth lens E4 has a negative refractive power, and has a convex object side surface S7 and a concave image side surface S8. The fifth lens E5 has a positive refractive power, and has a concave object side surface S9 and a convex image side surface S10. The sixth lens E6 has a positive refractive power, and has a convex object side surface S11 and a concave image side surface S12. The seventh lens E7 has a negative refractive power, and has a convex object side surface S13 and a concave image side surface S14. The difference between the maximum outer diameters of the fourth lens and the fifth lens is smaller than the difference between the maximum outer diameters of the fifth lens and the sixth lens.

The supporting member group includes a first supporting member P1, a second supporting member P2, a third supporting member P3, a fourth supporting member P4, a fifth supporting member P5 and a sixth supporting member P6. The first supporting member P1 is disposed between the first lens E1 and the second lens E2, the object side surface of the first supporting member P1 is at least partially in contact with the image side surface S2 of the first lens E1, and the image side surface of the first supporting member P1 is at least partially in contact with the object side surface S3 of the second lens E2. The second supporting member P2 is disposed between the second lens E2 and the third lens E3, the object side surface of the second supporting member P2 is at least partially in contact with the image side surface S4 of the second lens E2, and the image side surface of the second supporting member P2 is at least partially in contact with the object side surface S5 of the third lens E3. The third supporting member P3 is disposed between the third lens E3 and the fourth lens E4, the object side surface of the third supporting member P3 is at least partially in contact with the image side surface S6 of the third lens E3, and the image side surface of the third supporting member P3 is at least partially in contact with the object side surface S7 of the fourth lens E4. The fourth supporting member P4 is disposed between the fourth lens E4 and the fifth lens E5, the object side surface of the fourth supporting member P4 is at least partially in contact with the image side surface S8 of the fourth lens E4, and the image side surface of the fourth supporting member P4 is at least partially in contact with the object side surface S9 of the fifth lens E5. The fifth supporting member P5 is disposed between the fifth lens E5 and the sixth lens E6, the object side surface of the fifth supporting member P5 is at least partially in contact with the image side surface S10 of the fifth lens E5, and the image side surface of the fifth supporting member P5 is at least partially in contact with the object side surface S11 of the sixth lens E6. The sixth supporting member P6 is disposed between the sixth lens E6 and the seventh lens E7, the object side surface of the sixth supporting member P6 is at least partially in contact with the image side surface S12 of the sixth lens E6, and the image side surface of the sixth supporting member P6 is at least partially in contact with the object side surface S13 of the seventh lens E7.

In an example, a filter may be disposed between the seventh lens E7 and an imaging plane S17 (not shown), and the filter has an object side surface S15 (not shown) and an image side surface S16 (not shown). Light from an object passes through the surfaces S1 to S16 in order and is finally imaged on the imaging plane S17.

Table 5 shows a table of basic parameters of the lens group of the optical imaging lens assembly of Embodiment 5, wherein the units of the radius of curvature and thickness/distance are all millimeters (mm).

TABLE 5

| | | Radius of | | Material | | Cone |
|---|---|---|---|---|---|---|
| Surface No. | Surface type | curvature | Thickness | Refractive index | Abbe number | coefficient |
| OBJ | Spherical | Infinite | Infinite | | | |
| STO | Spherical | Infinite | −0.6600 | | | |
| S1 | Aspherical | 2.7932 | 1.0594 | 1.546 | 56.06 | 0.554 |
| S2 | Aspherical | 12.1337 | 0.1364 | | | −35.890 |
| S3 | Aspherical | 4.9141 | 0.3850 | 1.677 | 19.23 | 4.614 |
| S4 | Aspherical | 3.2218 | 0.4733 | | | 0.638 |
| S5 | Aspherical | 13.7776 | 0.6470 | 1.546 | 56.06 | −69.818 |
| S6 | Aspherical | 57.9192 | 0.2282 | | | −89.945 |
| S7 | Aspherical | 12.5055 | 0.4000 | 1.677 | 19.23 | −62.513 |
| S8 | Aspherical | 10.1262 | 0.2906 | | | −9.974 |
| S9 | Aspherical | −9.1115 | 0.7638 | 1.546 | 56.06 | −0.518 |
| S10 | Aspherical | −5.9845 | 0.0948 | | | 1.469 |
| S11 | Aspherical | 2.9978 | 0.5200 | 1.546 | 56.06 | −0.188 |
| S12 | Aspherical | 5.2037 | 0.6881 | | | −1.953 |
| S13 | Aspherical | 3.1081 | 0.5111 | 1.546 | 56.06 | −1.164 |
| S14 | Aspherical | 1.6292 | 1.0812 | | | −4.168 |
| S15 | Spherical | Infinite | 0.2100 | 1.518 | 64.17 | |
| S16 | Spherical | Infinite | 0.1212 | | | |
| S17 | Spherical | Infinite | | | | |

In this embodiment, the object side surface and the image side surface of any lens from the first lens E1 to the seventh lens E7 are both aspherical surfaces, wherein the surface profile of each aspherical surface can be defined by, but not limited to, formula (1) given in Embodiment 1 described above. Table 6 shows high-order coefficients A4, A6, A8, A10, A12, A14, A16, A18 and A20 of each of the aspherical surfaces S1 to S14 that are applicable in Embodiment 5.

TABLE 6

| Surface No. | A4 | A6 | A8 | A10 | A12 | A14 | A16 | A18 | A20 |
|---|---|---|---|---|---|---|---|---|---|
| S1 | −3.89E−03 | −6.65E−05 | −1.36E−03 | 1.42E−03 | −1.08E−03 | 4.96E−04 | −1.38E−04 | 2.10E−05 | −1.38E−06 |
| S2 | −3.29E−02 | 2.86E−02 | −1.99E−02 | 1.17E−02 | −5.83E−03 | 2.15E−03 | −5.27E−04 | 7.47E−05 | −4.60E−06 |
| S3 | −6.15E−02 | 3.51E−02 | −1.67E−02 | 8.95E−03 | −5.81E−03 | 3.01E−03 | −9.61E−04 | 1.65E−04 | −1.17E−05 |
| S4 | −3.67E−02 | 2.05E−02 | −1.06E−02 | 1.01E−02 | −9.47E−03 | 5.78E−03 | −2.05E−03 | 3.85E−04 | −2.93E−05 |
| S5 | −6.18E−03 | −1.60E−02 | 3.43E−02 | −5.57E−02 | 5.38E−02 | −3.23E−02 | 1.17E−02 | −2.34E−03 | 1.97E−04 |
| S6 | −2.49E−02 | 1.53E−02 | −2.98E−02 | 3.02E−02 | −2.07E−02 | 8.93E−03 | −2.29E−03 | 3.27E−04 | −2.04E−05 |
| S7 | −4.93E−02 | 4.33E−02 | −6.65E−02 | 6.51E−02 | −4.08E−02 | 1.60E−02 | −3.71E−03 | 4.65E−04 | −2.44E−05 |
| S8 | −4.52E−02 | 3.68E−02 | −4.02E−02 | 2.83E−02 | −1.32E−02 | 4.03E−03 | −7.63E−04 | 8.02E−05 | −3.56E−06 |
| S9 | −1.19E−02 | 2.38E−02 | −2.20E−02 | 1.08E−02 | −3.79E−03 | 1.02E−03 | −1.89E−04 | 1.99E−05 | −8.76E−07 |
| S10 | −5.43E−02 | 3.05E−02 | −1.51E−02 | 6.13E−03 | −1.99E−03 | 4.81E−04 | −7.37E−05 | 6.13E−06 | −2.09E−07 |
| S11 | −1.37E−02 | −9.51E−03 | 3.39E−04 | 1.06E−03 | −6.54E−04 | 2.06E−04 | −3.64E−05 | 3.33E−06 | −1.22E−07 |
| S12 | 5.02E−02 | −3.78E−02 | 1.27E−02 | −3.15E−03 | 5.82E−04 | −7.57E−05 | 6.42E−06 | −3.12E−07 | 6.51E−09 |
| S13 | −1.40E−01 | 4.02E−02 | −8.04E−03 | 1.16E−03 | −1.15E−04 | 7.49E−06 | −3.03E−07 | 6.92E−09 | −6.81E−11 |
| S14 | −7.75E−02 | 2.56E−02 | −6.24E−03 | 1.03E−03 | −1.09E−04 | 7.39E−06 | −3.07E−07 | 7.13E−09 | −7.11E−11 |

### Embodiment 6

FIG. 10 shows a schematic structural diagram of the optical imaging lens assembly according to Embodiment 6 of the present application. As shown in FIG. 10, the optical imaging lens assembly includes a lens barrel P0, and a seven-element lens group and a supporting member group disposed in the lens barrel P0. The seven-element lens group includes, in order from an object side to an image side along an optical axis: a first lens E1, a second lens E2, a third lens E3, a fourth lens E4, a fifth lens E5, a sixth lens E6, and a seventh lens E7. A diaphragm STO (not shown) is disposed on the object side of the first lens E1. The supporting member group includes a first supporting member P1, a second supporting member P2, a third supporting member P3, a fourth supporting member P4, a fifth supporting member P5 and a sixth supporting member P6.

The seven-element lens group of the optical imaging lens assembly of this embodiment has the same structure as the seven-element lens group of the optical imaging lens assembly in Embodiment 5, and basic parameters thereof are detailed in Tables 5 and 6 and will not be described in detail.

The difference between this embodiment and Embodiment 5 is that the structure dimensions of the lens barrel P0 and at least some components in the supporting member group are different.

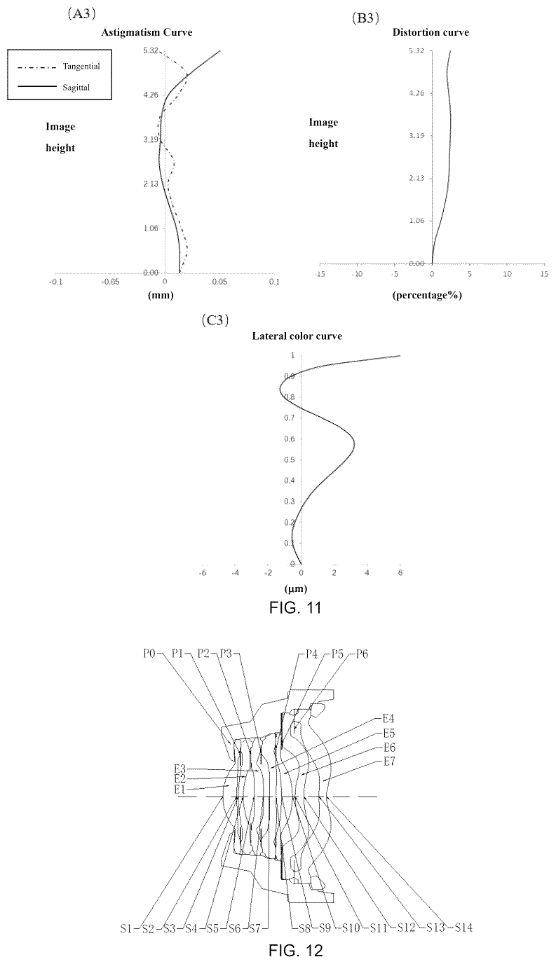

(A3) in FIG. 11 shows an astigmatism curve of the optical imaging lens assemblies of Embodiments 5 and 6, which represents the curvature of the tangential image plane and the curvature of the sagittal image plane. (B3) in FIG. 11 shows a distortion curve of the optical imaging lens assemblies of Embodiments 5 and 6, which represents distortion magnitude values corresponding to different field-of-view angles. (C3) in FIG. 11 shows a lateral color curve of the optical imaging lens assemblies of Embodiments 5 and 6, which represents the deviation of different image heights on the imaging plane after light passes through the lens assembly. According to FIG. 11, it can be seen that the optical imaging lens assemblies provided by Embodiments 5 and 6 can achieve good imaging quality.

### Embodiment 7

FIG. 12 shows a schematic structural diagram of the optical imaging lens assembly according to Embodiment 7 of the present application. As shown in FIG. 12, the optical imaging lens assembly includes a lens barrel P0, and a seven-element lens group and a supporting member group disposed in the lens barrel P0. The seven-element lens group includes, in order from an object side to an image side along an optical axis: a first lens E1, a second lens E2, a third lens E3, a fourth lens E4, a fifth lens E5, a sixth lens E6, and a seventh lens E7. A diaphragm STO (not shown) is disposed on the object side of the first lens E1.

The first lens E1 has a positive refractive power, and has a convex object side surface S1 and a concave image side surface S2. The second lens E2 has a negative refractive power, and has a convex object side surface S3 and a concave image side surface S4. The third lens E3 has a positive refractive power, and has a convex object side surface S5 and a concave image side surface S6. The fourth lens E4 has a negative refractive power, and has a convex object side surface S7 and a concave image side surface S8. The fifth lens E5 has a positive refractive power, and has a concave object side surface S9 and a convex image side surface S10. The sixth lens E6 has a positive refractive power, and has a convex object side surface S11 and a concave image side surface S12. The seventh lens E7 has a negative refractive power, and has a convex object side surface S13 and a concave image side surface S14. The difference between the maximum outer diameters of the fourth lens and the fifth lens is smaller than the difference between the maximum outer diameters of the fifth lens and the sixth lens.

The supporting member group includes a first supporting member P1, a second supporting member P2, a third supporting member P3, a fourth supporting member P4, a fifth supporting member P5 and a sixth supporting member P6. The first supporting member P1 is disposed between the first lens E1 and the second lens E2, the object side surface of the first supporting member P1 is at least partially in contact with the image side surface S2 of the first lens E1, and the image side surface of the first supporting member P1 is at least partially in contact with the object side surface S3 of the second lens E2. The second supporting member P2 is disposed between the second lens E2 and the third lens E3, the object side surface of the second supporting member P2 is at least partially in contact with the image side surface S4 of the second lens E2, and the image side surface of the second supporting member P2 is at least partially in contact with the object side surface S5 of the third lens E3. The third supporting member P3 is disposed between the third lens E3 and the fourth lens E4, the object side surface of the third supporting member P3 is at least partially in contact with the image side surface S6 of the third lens E3, and the image side surface of the third supporting member P3 is at least partially in contact with the object side surface S7 of the fourth lens E4. The fourth supporting member P4 is disposed between the fourth lens E4 and the fifth lens E5, the object side surface of the fourth supporting member P4 is at least partially in contact with the image side surface S8 of the fourth lens E4, and the image side surface of the fourth supporting member P4 is at least partially in contact with the object side surface S9 of the fifth lens E5. The fifth supporting member P5 is disposed between the fifth lens E5 and the sixth lens E6, the object side surface of the fifth supporting member P5 is at least partially in contact with the image side surface S10 of the fifth lens E5, and the image side surface of the fifth supporting member P5 is at least partially in contact with the object side surface S11 of the sixth lens E6. The sixth supporting member P6 is disposed between the sixth lens E6 and the seventh lens E7, the object side surface of the sixth supporting member P6 is at least partially in contact with the image side surface S12 of the sixth lens E6, and the image side surface of the sixth supporting member P6 is at least partially in contact with the object side surface S13 of the seventh lens E7.

In an example, a filter may be disposed between the seventh lens E7 and an imaging plane S17 (not shown), and the filter has an object side surface S15 (not shown) and an image side surface S16 (not shown). Light from an object passes through the surfaces S1 to S16 in order and is finally imaged on the imaging plane S17.

Table 7 shows a table of basic parameters of the lens group of the optical imaging lens assembly of Embodiment 7, wherein the units of the radius of curvature and thickness/distance are all millimeters (mm).

TABLE 7

| | | Radius of | | Material | | Cone |
|---|---|---|---|---|---|---|
| Surface No. | Surface type | curvature | Thickness | Refractive index | Abbe number | coefficient |
| OBJ | Spherical | Infinite | Infinite | | | |
| STO | Spherical | Infinite | −0.6976 | | | |
| S1 | Aspherical | 2.7541 | 0.8248 | 1.546 | 55.99 | 0.688 |
| S2 | Aspherical | 11.7210 | 0.0889 | | | 1.778 |
| S3 | Aspherical | 5.0134 | 0.2881 | 1.678 | 19.24 | 4.543 |
| S4 | Aspherical | 3.4049 | 0.6434 | | | 0.615 |
| S5 | Aspherical | 21.5077 | 0.5457 | 1.546 | 55.99 | 9.513 |
| S6 | Aspherical | 269.8597 | 0.3532 | | | 35.742 |
| S7 | Aspherical | 9.5915 | 0.3968 | 1.678 | 19.24 | −13.098 |
| S8 | Aspherical | 7.9006 | 0.3236 | | | −3.679 |
| S9 | Aspherical | −11.7454 | 0.6363 | 1.546 | 55.99 | 9.188 |
| S10 | Aspherical | −6.1932 | 0.1569 | | | 1.516 |
| S11 | Aspherical | 3.1596 | 0.5294 | 1.546 | 55.99 | −0.281 |
| S12 | Aspherical | 6.5218 | 0.8823 | | | 0.532 |
| S13 | Aspherical | 3.9748 | 0.4467 | 1.546 | 55.99 | −1.061 |
| S14 | Aspherical | 1.7097 | 1.0053 | | | −4.830 |
| S15 | Spherical | Infinite | 0.2100 | 1.518 | 64.17 | |
| S16 | Spherical | Infinite | 0.1000 | | | |
| S17 | Spherical | Infinite | | | | |

In this embodiment, the object side surface and the image side surface of any lens from the first lens E1 to the seventh lens E7 are both aspherical surfaces, wherein the surface profile of each aspherical surface can be defined by, but not limited to, formula (1) given in Embodiment 1 described above. Table 8 shows high-order coefficients A4, A6, A8, A10, A12, A14, A16, A18 and A20 of each of the aspherical surfaces S1 to S14 that are applicable in Embodiment 7.

TABLE 8

| Surface No. | A4 | A6 | A8 | A10 | A12 | A14 | A16 | A18 | A20 |
|---|---|---|---|---|---|---|---|---|---|
| S1 | −3.50E−03 | 1.19E−03 | −3.34E−03 | 3.96E−03 | −3.06E−03 | 1.45E−03 | −4.18E−04 | 6.74E−05 | −4.82E−06 |
| S2 | −2.97E−02 | 2.92E−02 | −2.17E−02 | 1.31E−02 | −6.52E−03 | 2.47E−03 | −6.45E−04 | 1.00E−04 | −6.88E−06 |
| S3 | −5.63E−02 | 3.38E−02 | −2.02E−02 | 1.24E−02 | −7.89E−03 | 4.10E−03 | −1.39E−03 | 2.67E−04 | −2.14E−05 |
| S4 | −2.99E−02 | 6.89E−03 | 1.87E−02 | −4.10E−02 | 4.66E−02 | −3.22E−02 | 1.35E−02 | −3.17E−03 | 3.18E−04 |
| S5 | −1.37E−02 | −8.59E−03 | 1.12E−02 | −2.14E−02 | 2.36E−02 | −1.67E−02 | 7.29E−03 | −1.76E−03 | 1.83E−04 |
| S6 | −1.65E−02 | −1.29E−02 | 1.92E−02 | −2.60E−02 | 2.07E−02 | −1.04E−02 | 3.21E−03 | −5.56E−04 | 4.11E−05 |
| S7 | −3.05E−02 | 1.28E−02 | −2.31E−02 | 2.43E−02 | −1.57E−02 | 6.31E−03 | −1.50E−03 | 1.93E−04 | −1.04E−05 |
| S8 | −3.04E−02 | 1.83E−02 | −2.26E−02 | 1.72E−02 | −8.42E−03 | 2.66E−03 | −5.09E−04 | 5.28E−05 | −2.28E−06 |
| S9 | −1.56E−02 | 2.64E−02 | −2.78E−02 | 1.80E−02 | −8.31E−03 | 2.58E−03 | −4.86E−04 | 4.95E−05 | −2.08E−06 |
| S10 | −5.77E−02 | 3.21E−02 | −1.74E−02 | 8.31E−03 | −3.10E−03 | 7.87E−04 | −1.19E−04 | 9.60E−06 | −3.15E−07 |
| S11 | −8.16E−03 | −1.10E−02 | 1.93E−03 | −3.35E−04 | 8.74E−05 | −1.46E−05 | 7.69E−07 | 4.43E−08 | −3.93E−09 |
| S12 | 6.11E−02 | −3.88E−02 | 1.08E−02 | −1.99E−03 | 2.57E−04 | −2.35E−05 | 1.47E−06 | −5.72E−08 | 1.01E−09 |
| S13 | −1.24E−01 | 3.71E−02 | −8.26E−03 | 1.30E−03 | −1.35E−04 | 8.89E−06 | −3.62E−07 | 8.29E−09 | −8.21E−11 |
| S14 | −6.36E−02 | 1.94E−02 | −4.35E−03 | 6.21E−04 | −5.43E−05 | 2.85E−06 | −8.42E−08 | 1.19E−09 | −4.51E−12 |

### Embodiment 8

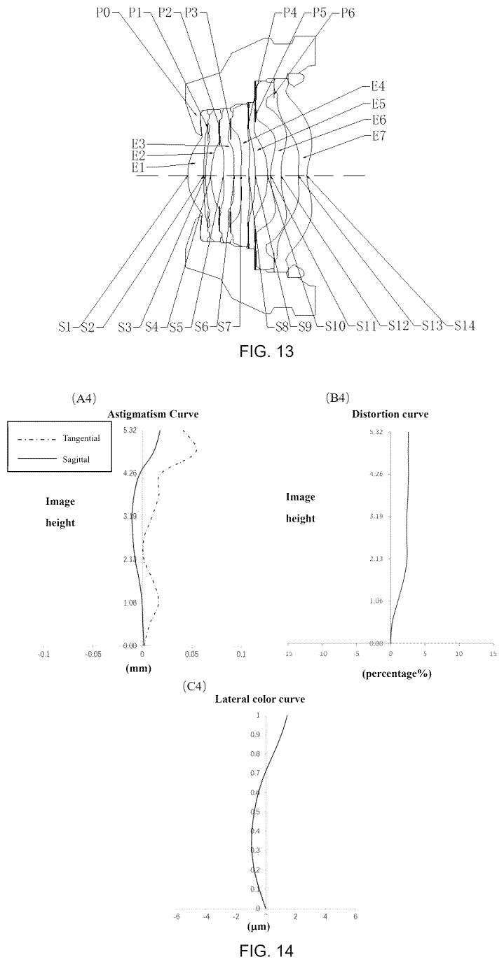

FIG. 13 shows a schematic structural diagram of the optical imaging lens assembly according to Embodiment 8 of the present application. As shown in FIG. 13, the optical imaging lens assembly includes a lens barrel P0, and a seven-element lens group and a supporting member group disposed in the lens barrel P0. The seven-element lens group includes, in order from an object side to an image side along an optical axis: a first lens E1, a second lens E2, a third lens E3, a fourth lens E4, a fifth lens E5, a sixth lens E6, and a seventh lens E7. A diaphragm STO (not shown) is disposed on the object side of the first lens E1. The supporting member group includes a first supporting member P1, a second supporting member P2, a third supporting member P3, a fourth supporting member P4, a fifth supporting member P5 and a sixth supporting member P6.

The seven-element lens group of the optical imaging lens assembly of this embodiment has the same structure as the seven-element lens group of the optical imaging lens assembly in Embodiment 7, and basic parameters thereof are detailed in Tables 7 and 8 and will not be described in detail.

The difference between this embodiment and Embodiment 7 is that the structure dimensions of the lens barrel P0 and at least some components in the supporting member group are different.

(A4) in FIG. 14 shows an astigmatism curve of the optical imaging lens assemblies of Embodiments 7 and 8, which represents the curvature of the tangential image plane and the curvature of the sagittal image plane. (B2) in FIG. 14 shows a distortion curve of the optical imaging lens assemblies of Embodiments 7 and 8, which represents distortion magnitude values corresponding to different field-of-view angles. (C4) in FIG. 14 shows a lateral color curve of the optical imaging lens assemblies of Embodiments 7 and 8, which represents the deviation of different image heights on the imaging plane after light passes through the lens assembly. According to FIG. 14, it can be seen that the optical imaging lens assemblies provided by Embodiments 7 and 8 can achieve good imaging quality.

Table 9 gives the parameter values of FNO, Semi-FOV, f, f1, f2, f3, f4, f5, f6, f7 and SG11 in each of Embodiments 1 to 8.

TABLE 9

| | Embodiment | | | | | | | |
|---|---|---|---|---|---|---|---|---|
| Parameter | 1 | 2 | 3 | 4 | 5 | 6 | 7 | 8 |
| FNO | 1.59 | | 1.60 | | 1.61 | | 1.61 | |
| Semi-FOV (°) | 39.50 | | 40.81 | | 40.60 | | 40.98 | |
| f (mm) | 5.90 | | 5.99 | | 6.06 | | 5.96 | |
| f1 (mm) | 6.24 | | 6.41 | | 6.39 | | 6.38 | |
| f2 (mm) | −14.97 | | −15.79 | | −15.22 | | −16.88 | |
| f3 (mm) | 39.55 | | 25.67 | | 32.96 | | 42.75 | |
| f4 (mm) | −57.44 | | −43.21 | | −84.35 | | −73.07 | |
| f5 (mm) | 19.32 | | 22.85 | | 29.42 | | 23.05 | |
| f6 (mm) | 11.58 | | 11.51 | | 11.96 | | 10.63 | |
| f7 (mm) | −6.46 | | −6.25 | | −7.15 | | −5.90 | |
| SG11 (mm) | 0.657 | | 0.657 | | 0.657 | | 0.657 | |
| | Z | Z | Z | Z | Z | Z | Z | Z |

Table 10 gives the values of parameters of the lens barrel P0 and at least some components of the supporting member group in each of Embodiments 1 to 8. Some parameters can be measured according to the labeling method shown in FIG. 1, and the units of the parameters listed in Table 10 are all millimeters (mm).

TABLE 10

| | Embodiment | | | | | | | |
|---|---|---|---|---|---|---|---|---|
| Parameter | 1 | 2 | 3 | 4 | 5 | 6 | 7 | 8 |
| d4s | 4.526 | 4.526 | 4.553 | 4.545 | 4.490 | 4.545 | 4.674 | 4.671 |
| D4m | 7.291 | 7.291 | 7.290 | 7.282 | 7.285 | 7.282 | 7.285 | 7.301 |
| d5s | 5.154 | 5.154 | 5.344 | 5.344 | 5.293 | 5.344 | 5.345 | 5.372 |
| D5s | 8.973 | 8.973 | 8.973 | 8.128 | 8.973 | 8.973 | 9.533 | 9.413 |
| d0s | 7.190 | 7.190 | 7.210 | 7.190 | 7.190 | 7.190 | 7.190 | 7.190 |
| d0m | 10.341 | 10.341 | 10.841 | 10.725 | 10.841 | 10.732 | 11.091 | 11.040 |
| EP01 | 1.232 | 1.172 | 1.232 | 1.172 | 1.232 | 1.172 | 1.108 | 1.124 |
| EP23 | 0.648 | 0.549 | 0.611 | 0.549 | 0.519 | 0.527 | 0.582 | 0.535 |
| CP3 | 0.022 | 0.022 | 0.022 | 0.022 | 0.022 | 0.022 | 0.022 | 0.022 |
| EP34 | 0.732 | 0.809 | 0.707 | 0.779 | 0.711 | 0.716 | 0.835 | 0.892 |
| CP4 | 0.022 | 0.022 | 0.022 | 0.022 | 0.022 | 0.022 | 0.022 | 0.022 |
| EP45 | 0.433 | 0.433 | 0.458 | 0.462 | 0.507 | 0.506 | 0.342 | 0.352 |
| CP5 | 0.022 | 0.022 | 0.022 | 0.022 | 0.022 | 0.022 | 0.022 | 0.022 |
| d1s | 3.459 | 3.497 | 3.494 | 3.534 | 3.592 | 3.632 | 3.519 | 3.505 |
| D0m | 11.563 | 12.322 | 12.322 | 12.322 | 12.322 | 12.322 | 12.163 | 13.922 |

In summary, the optical imaging lens assemblies in Embodiments 1 to 8 satisfy the relationships shown in Table 11.

TABLE 11

| | Embodiment | | | | | | | |
|---|---|---|---|---|---|---|---|---|
| Conditional Expression | 1 | 2 | 3 | 4 | 5 | 6 | 7 | 8 |
| FNO/tan(Semi-FOV) | 1.92 | 1.92 | 1.85 | 1.85 | 1.88 | 1.88 | 1.85 | 1.85 |
| EP45/(CP4 + CP5) | 9.84 | 9.84 | 10.41 | 10.50 | 11.52 | 11.50 | 7.77 | 8.00 |
| CT4/EP34*N4 | 0.92 | 0.84 | 0.91 | 0.83 | 0.94 | 0.94 | 0.80 | 0.75 |
| f5/d5s | 3.75 | 3.75 | 4.28 | 4.28 | 5.56 | 5.50 | 4.31 | 4.29 |
| (D5s − D4m)/d4s | 0.37 | 0.37 | 0.37 | 0.19 | 0.38 | 0.37 | 0.48 | 0.45 |
| EP45/CT5 | 0.49 | 0.49 | 0.62 | 0.63 | 0.66 | 0.66 | 0.54 | 0.55 |
| EP23/CT3 | 1.15 | 0.98 | 1.02 | 0.92 | 0.80 | 0.81 | 1.07 | 0.98 |
| (d0s + D0m)/EPD | 5.04 | 5.25 | 5.22 | 5.22 | 5.19 | 5.19 | 5.23 | 5.70 |
| d0s/(EP01 + CT1) | 3.30 | 3.39 | 3.25 | 3.33 | 3.14 | 3.22 | 3.72 | 3.69 |
| d0m/d0s | 1.44 | 1.44 | 1.50 | 1.49 | 1.51 | 1.49 | 1.54 | 1.54 |
| T34/CP3 | 11.10 | 11.10 | 16.56 | 16.56 | 10.37 | 10.37 | 16.05 | 16.05 |
| (R10 − R9)/d5s | 0.76 | 0.76 | 0.65 | 0.65 | 0.59 | 0.59 | 1.04 | 1.03 |
| f1/(R1 + R2) | 0.33 | 0.33 | 0.38 | 0.38 | 0.43 | 0.43 | 0.44 | 0.44 |
| dos/d1s | 2.08 | 2.06 | 2.06 | 2.03 | 2.00 | 1.98 | 2.04 | 2.05 |
| EP01/SG11 | 1.88 | 1.78 | 1.88 | 1.78 | 1.88 | 1.78 | 1.69 | 1.71 |

The present application further provides an electronic device equipped with the optical imaging lens assembly described above. The electronic device may be a wearable device such as a VR helmet, a smart watch, and smart glasses, an independent imaging device such as a digital camera, or a mobile electronic device such as a mobile phone.

The above description is only the preferred embodiments of the present application and the explanation of the applied technical principle. It should be understood by those skilled in the art that the scope of disclosure involved in the present application is not limited to technical solutions formed by specific combinations of the above technical features, and at the same time, should also cover other technical solutions formed by any combination of the above technical features or equivalent features thereof without departing from the concept of the disclosure. For example, the above features and (but not limited to) the technical features with similar functions disclosed in the present application are replaced with each other to form technical solutions.

What is claimed is:

1. An optical imaging lens assembly, comprising:
a lens group, comprising a first lens, a second lens, a third lens, a fourth lens, a fifth lens, a sixth lens and a seventh lens having refractive powers and arranged in order from an object side to an image side along an optical axis, wherein a difference between maximum outer diameters of the fourth lens and the fifth lens is smaller than a difference between maximum outer diameters of the fifth lens and the sixth lens;
a supporting member group, comprising a third supporting member, a fourth supporting member and a fifth supporting member, wherein the third supporting member is disposed between the third lens and the fourth lens and in contact with an image side surface of the third lens, the fourth supporting member is disposed between the fourth lens and the fifth lens and in contact with an image side surface of the fourth lens, and the fifth supporting member is disposed between the fifth lens and the sixth lens and in contact with an image side surface of the fifth lens; and
a lens barrel, accommodating the lens group and the supporting member group;
wherein the number of lenses having refractive powers in the lens group is seven; and
the optical imaging lens assembly satisfies:
$$1. 80 < FNO / tan ( Semi - FOV ) < 1.95 ; \\ 7.75 < EP 45 / ( CP 4 + CP 5 ) < 11.55 ; and \\ 0.7 < CT 4 / EP 34 * N 4 < 0 \text{.96} ;$$
where FNO is an f-number of the optical imaging lens assembly, EP45 is a distance from an image side surface of the fourth supporting member to an object side surface of the fifth supporting member along the direction of the optical axis, CP4 is a maximum thickness of the fourth supporting member, CP5 is a maximum thickness of the fifth supporting member, CT4 is a center thickness of the fourth lens on the optical axis, EP34 is a distance from an image side surface of the third supporting member to an object side surface of the fourth supporting member along the direction of the optical axis, N4 is a refractive index of the fourth lens, and Semi-FOV is half of a maximum field-of-view angle of the optical imaging lens assembly.

2. The optical imaging lens assembly according to claim 1, wherein the supporting member group further comprises a first supporting member, and the first supporting member is disposed between the first lens and the second lens and in contact with an image side surface of the first lens; and
the optical imaging lens assembly satisfies: 3.1<d0s/(EP01+CT1)<3.75, where d0s is an inner diameter of an object side end surface of the lens barrel, EP01 is a distance between the object side end surface of the lens barrel and an object side surface of the first supporting member along the direction of the optical axis, and CT1 is a center thickness of the first lens on the optical axis.

3. The optical imaging lens assembly according to claim 1, wherein the supporting member group further comprises a first supporting member, and the first supporting member is disposed between the first lens and the second lens and in contact with an image side surface of the first lens; and
the optical imaging lens assembly satisfies: 0.3<f1/(R1+R2)<0.5 and 1.95<d0s/d1s<2.1, where f1 is an effective focal length of the first lens, R1 is a radius of curvature of an object side surface of the first lens, R2 is a radius of curvature of an image side surface of the first lens, d0s is an inner diameter of an object side end surface of the lens barrel, and d1s is an inner diameter of an object side surface of the first supporting member.

4. The optical imaging lens assembly according to claim 1, wherein the supporting member group further comprises a first supporting member, and the first supporting member is disposed between the first lens and the second lens and in contact with an image side surface of the first lens; and
the optical imaging lens assembly satisfies: 1.65<EP01/SG11<1.9, wherein EP01 is a distance between an object side end surface of the lens barrel and an object side surface of the first supporting member along the direction of the optical axis, and SG11 is an on-axis distance from an intersection of an object side surface of the first lens and the optical axis to a non-effective radial section of the object side surface of the first lens.

5. The optical imaging lens assembly according to claim 1, wherein the supporting member group further comprises a second supporting member, and the second supporting member is disposed between the second lens and the third lens and in contact with an image side surface of the second lens; and
the optical imaging lens assembly satisfies: 0.75<EP23/CT3<1.2, where EP23 is a distance from an image side surface of the second supporting member to an object side surface of the third supporting member along the direction of the optical axis, and CT3 is a center thickness of the third lens on the optical axis.

6. The optical imaging lens assembly according to claim 1, wherein the optical imaging lens assembly satisfies: 0.45<EP45/CT5<0.7, where CT5 is a center thickness of the fifth lens on the optical axis.

7. The optical imaging lens assembly according to claim 1, wherein the optical imaging lens assembly satisfies: 3.7<f5/d5s<5.6, where f5 is an effective focal length of the fifth lens, and d5s is an inner diameter of an object side surface of the fifth supporting member.

8. The optical imaging lens assembly according to claim 1, wherein the optical imaging lens assembly satisfies: 0.55<(R10−R9)/d5s<1.05, where R9 is a radius of curvature of an object side surface of the fifth lens, R10 is a radius of curvature of an image side surface of the fifth lens, and d5s is an inner diameter of an object side surface of the fifth supporting member.

9. The optical imaging lens assembly according to claim 1, wherein the optical imaging lens assembly satisfies: 0.15<(D5s−D4m)/d4s<0.5, where D5s is an outer diameter of an object side surface of the fifth supporting member, D4m is an outer diameter of an image side surface of the fourth supporting member, and d4s is an inner diameter of an object side surface of the fourth supporting member.

10. The optical imaging lens assembly according to claim 1, wherein the optical imaging lens assembly satisfies: 10.35<T34/CP3<16.6, where T34 is an air gap between the third lens and the fourth lens on the optical axis, and CP3 is a maximum thickness of the third supporting member.

11. The optical imaging lens assembly according to claim 1, wherein the optical imaging lens assembly satisfies: 5.0<(d0s+D0m)/EPD<5.75, where d0s is an inner diameter of an object side end surface of the lens barrel, EPD is an entrance pupil diameter of the optical imaging lens assembly, and D0m is an outer diameter of an image side end surface of the lens barrel.

12. The optical imaging lens assembly according to claim 11, wherein the supporting member group further comprises a first supporting member, and the first supporting member is disposed between the first lens and the second lens and in contact with an image side surface of the first lens; and
the optical imaging lens assembly satisfies: 3.1<d0s/(EP01+CT1)<3.75, where d0s is an inner diameter of an object side end surface of the lens barrel, EP01 is a distance between the object side end surface of the lens barrel and an object side surface of the first supporting member along the direction of the optical axis, and CT1 is a center thickness of the first lens on the optical axis.

13. The optical imaging lens assembly according to claim 11, wherein the supporting member group further comprises a first supporting member, and the first supporting member is disposed between the first lens and the second lens and in contact with an image side surface of the first lens; and
the optical imaging lens assembly satisfies: 0.3<f1/(R1+R2)<0.5 and 1.95<d0s/d1s<2.1, where f1 is an effective focal length of the first lens, R1 is a radius of curvature of an object side surface of the first lens, R2 is a radius of curvature of an image side surface of the first lens, d0s is an inner diameter of an object side end surface of the lens barrel, and d1s is an inner diameter of an object side surface of the first supporting member.

14. The optical imaging lens assembly according to claim 11, wherein the supporting member group further comprises a first supporting member, and the first supporting member is disposed between the first lens and the second lens and in contact with an image side surface of the first lens; and
the optical imaging lens assembly satisfies: 1.65<EP01/SG11<1.9, wherein EP01 is a distance between an object side end surface of the lens barrel and an object side surface of the first supporting member along the direction of the optical axis, and SG11 is an on-axis distance from an intersection of an object side surface of the first lens and the optical axis to a non-effective radial section of the object side surface of the first lens.

15. The optical imaging lens assembly according to claim 11, wherein the supporting member group further comprises a second supporting member, and the second supporting member is disposed between the second lens and the third lens and in contact with an image side surface of the second lens; and
the optical imaging lens assembly satisfies: 0.75<EP23/CT3<1.2, where EP23 is a distance from an image side surface of the second supporting member to an object side surface of the third supporting member along the direction of the optical axis, and CT3 is a center thickness of the third lens on the optical axis.

16. The optical imaging lens assembly according to claim 1, wherein the optical imaging lens assembly satisfies: 1.4<d0m/d0s<1.55, where d0m is an inner diameter of the image side end surface of the lens barrel, and d0s is an inner diameter of the object side end surface of the lens barrel.

17. The optical imaging lens assembly according to claim 16, wherein the supporting member group further comprises a first supporting member, and the first supporting member is disposed between the first lens and the second lens and in contact with an image side surface of the first lens; and
the optical imaging lens assembly satisfies: 3.1<d0s/(EP01+CT1)<3.75, where d0s is an inner diameter of an object side end surface of the lens barrel, EP01 is a distance between the object side end surface of the lens barrel and an object side surface of the first supporting member along the direction of the optical axis, and CT1 is a center thickness of the first lens on the optical axis.

18. The optical imaging lens assembly according to claim 16, wherein the supporting member group further comprises a first supporting member, and the first supporting member is disposed between the first lens and the second lens and in contact with an image side surface of the first lens; and
the optical imaging lens assembly satisfies: 0.3<f1/(R1+R2)<0.5 and 1.95<d0s/d1s<2.1, where f1 is an effective focal length of the first lens, R1 is a radius of curvature of an object side surface of the first lens, R2 is a radius of curvature of an image side surface of the first lens, d0s is an inner diameter of an object side end surface of the lens barrel, and d1s is an inner diameter of an object side surface of the first supporting member.

19. The optical imaging lens assembly according to claim 16, wherein the supporting member group further comprises a first supporting member, and the first supporting member is disposed between the first lens and the second lens and in contact with an image side surface of the first lens; and
the optical imaging lens assembly satisfies: 1.65<EP01/SG11<1.9, wherein EP01 is a distance between an object side end surface of the lens barrel and an object side surface of the first supporting member along the direction of the optical axis, and SG11 is an on-axis distance from an intersection of an object side surface of the first lens and the optical axis to a non-effective radial section of the object side surface of the first lens.

20. The optical imaging lens assembly according to claim 16, wherein the supporting member group further comprises a second supporting member, and the second supporting member is disposed between the second lens and the third lens and in contact with an image side surface of the second lens; and
the optical imaging lens assembly satisfies: 0.75<EP23/CT3<1.2, where EP23 is a distance from an image side surface of the second supporting member to an object side surface of the third supporting member along the direction of the optical axis, and CT3 is a center thickness of the third lens on the optical axis.
